(19) United States
(12) Patent Application Publication
(10) Pub. No.: US 2023/0206150 A1
(43) Pub. Date: Jun. 29, 2023

(54) DYNAMIC LODGING RESOURCE PREDICTION SYSTEM

(71) Applicant: Avalara, Inc., Seattle, WA (US)

(72) Inventor: Andrew Brandon Chan, Chapel Hill, NC (US)

(21) Appl. No.: 17/564,061

(22) Filed: Dec. 28, 2021

(51) Int. Cl. G06Q 10/06; G06Q 10/08

(52) U.S. Cl. CPC G06Q 10/06315; G06Q 10/087

(57) ABSTRACT

Systems and methods electronically obtain lodging operator data regarding a plurality of sources and corresponding amounts of resources received from the sources for lodging stays. The lodging operator data includes lodging stay data regarding the lodging stays associated with a lodging operator and other data regarding the lodging operator. The system electronically determines lodging inventory data of the lodging operator in the domains based on the lodging operator data and electronically generates, based on the lodging stay data and the domain-specific lodging inventory data, lodging occupancy rates of lodging inventory for the one or more of the plurality of domains. Comparing domain-specific lodging inventory data to lodging occupancy rates, as well as considering data indicative of resources received for lodging stays, results in a prediction value being generated regarding future lodging availability and/or an amount of resources recommended for lodging operators to receive for providing lodging stays.

### TECHNICAL FIELD

The technical field relates to computer networks, and particularly to networked automated systems for dynamic lodging resource prediction.

### BRIEF SUMMARY

The present description gives instances of computer systems, devices and storage media that may store programs and methods. Embodiments of the system may determine, by a specialized computer system, a prediction value of future resources associated with future lodging stays in the one or more of a plurality of domains. According to various example embodiments, the prediction value is determined based on domain-specific lodging inventory data and lodging occupancy rates generated, for example, by performing tens or hundreds of operations of specialized computing systems per second, which is much faster than a human mind can do. Such speed of operations, and thus the use of such computing systems and networks, are integral to the embodiments described herein because such operations would be practically useless unless they are able to be applied to hundreds or thousands of computer network clients simultaneously or concurrently across computer networks and to the vast volumes of data that change in real-time provided by such computer network clients. Implementing a practical application of the embodiments described herein to hundreds or thousands of computer network clients simultaneously or concurrently across computer networks on which they operate and to the vast volumes of data that change in real-time provided by such computer network clients is impossible to do in the human mind.

In an example embodiment, a lodging data analysis engine utilizes artificial intelligence and/or machine learning trained on such feedback data, previous price recommendations and/or other prediction values and correlates those to other data received by the lodging data analysis engine to adjust recommended prices and other prediction values accordingly in real time or near real time. Such adjusted data may then be electronically provided as a data stream via an application programming interface (API) automatically over a computer network concurrently or simultaneously to computer network clients, thus increasing and improving the accuracy and efficiency of computerized automated enterprise resource planning (ERP) technology and networks.

Therefore, the systems and methods described herein for dynamic lodging resource prediction improve the functioning of computer or other hardware, such as by reducing the processing, storage, and/or data transmission resources needed to perform various tasks, including lodging resource prediction, thereby enabling the tasks to be performed by less capable, capacious, and/or expensive hardware devices, enabling the tasks to be performed with less latency and/or preserving more of the conserved resources for use in performing other tasks or additional instances of the same task.

As shown above and in more detail throughout the present disclosure, the present disclosure provides technical improvements in computer networks and existing computerized systems to facilitate availability, accuracy and efficiency of computing resources to perform dynamic lodging resource prediction.

These and other features and advantages of the claimed invention will become more readily apparent in view of the embodiments described and illustrated in this specification, namely in this written specification and the associated drawings.

### BRIEF DESCRIPTION OF THE SEVERAL VIEWS OF THE DRAWINGS

The components in the drawings are not necessarily drawn to scale relative to each other. Like reference numerals designate corresponding parts throughout the several views.

FIG. 1 is a diagram showing sample aspects of embodiments of the present disclosure.

FIG. 2 is a diagram that repeats some of the digital main rules of FIG. 1 in more detail, and juxtaposes them with a flowchart portion for a sample method of how it may be recognized that conditions of a certain digital main rule can be met for its consequent to be applied, all according to embodiments of the present disclosure.

FIG. 3A is a flowchart for illustrating a sample method according to embodiments of the present disclosure.

FIG. 3B is a flowchart for illustrating a sample method for determining a prediction value according to embodiments of the present disclosure.

FIG. 3C is a flowchart for illustrating a sample method involving continuing to automatically update metrics data based on determined differences between additional feedback resource data and the updated metrics data according to embodiments of the present disclosure.

FIG. 3D is a flowchart for illustrating a sample method for determining lodging inventory data according to embodiments of the present disclosure.

FIG. 3E is a flowchart for illustrating a sample method for determining lodging inventory data based on received data indicative of lodging available from the lodging operator on public electronic listings according to embodiments of the present disclosure.

FIG. 4 is a block diagram showing additional components of sample computer systems according to embodiments of the present disclosure.

FIG. 5 is a diagram of sample aspects for describing operational examples and use cases of embodiments of the present disclosure that are improvements in automated computerized systems.

FIG. 6 is an overview block diagram illustrating an example dynamic lodging resource prediction system including a lodging data analysis engine and a technical environment in which the system may be implemented that is an improvement in automated computerized systems, according to various embodiments of the present disclosure.

FIG. 7 is a data flow diagram that shows an example data flow through an online software platform (OSP) in a dynamic lodging resource prediction system and illustrates an improvement in automated computerized systems, according to various embodiments of the present disclosure.

FIG. 8 is a sample view of a User Interface (UI) for an OSP in which lodging revenue data is provided or auto-filled in a dynamic lodging resource prediction system in a use case of an embodiment according to various embodiments of the present disclosure.

FIG. 9 is a sample view of a User Interface (UI) for an OSP illustrating an example electronic lodging tax return document from which data may be automatically extracted in a dynamic lodging resource prediction system in a use case of an embodiment according to various embodiments of the present disclosure.

FIG. 10 is a sample view of a User Interface (UI) for an OSP illustrating an example output from a dynamic lodging resource prediction system in a use case of an embodiment according to various embodiments of the present disclosure.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, that embodiments of the inventive subject matter may be practiced without these specific details. In general, well-known structures and methods associated with underlying technology have not been shown or described in detail to avoid unnecessarily obscuring descriptions of the preferred embodiments.

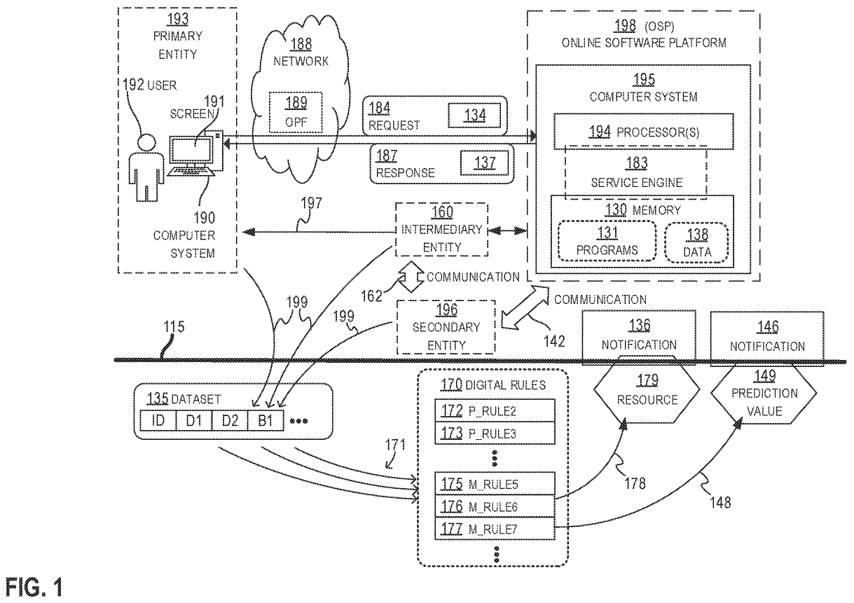

FIG. 1 is a diagram showing sample aspects of embodiments of the present disclosure. In particular, in an example embodiment, a dynamic lodging resource prediction system determines, via the service engine 183, a prediction value of future resources associated with future lodging stays in one or more of a plurality of domains. The prediction value may be determined based on generated domain-specific lodging inventory data and generated lodging occupancy rates that are generated by the service engine 183 using data received via communication network 188 from a variety of sources, such as, for example, primary entity 193 and other entities and systems.

A thick line 115 separates this diagram, although not completely or rigorously, into a top portion and a bottom portion. Above the line 115 the emphasis is mostly on entities, components, their relationships, and their interactions, while below the emphasis is mostly processing of data that takes place often within one or more of the components above the line 115.

Above the line 115, a sample computer system 195 according to embodiments is shown. The computer system 195 has one or more processors 194 and a memory 130. The memory 130 stores programs 131 and data 138. The one or more processors 194 and the memory 130 of the computer system 195 thus implement a service engine 183. Additional implementation details for the computer system 195 are given later in this document.

The computer system 195 can be located in “the cloud.” In fact, the computer system 195 may optionally be implemented as part of an online software platform (OSP) 198. The OSP 198 can be configured to perform one or more predefined services, for example, via operations of the service engine 183. Such services can be searches, determinations, computations, verifications, notifications, the transmission of specialized information, including data that effectuates payments or remits resources, data representing prediction values (e.g., based on the data that effectuates payments or remits resources), the generation and transmission of documents, the online accessing other systems to effect registrations, and so on, including what is described in this document. Such services can be provided as a Software as a Service (SaaS).

A user 192 may be standalone. The user 192 may use a computer system 190 that has a screen 191, on which User Interfaces (UIs) may be shown. Additional sample implementation details for the computer system 190 are given later in this document. In embodiments, the user 192 and the computer system 190 are considered part of a primary entity 193, which can be referred to also merely as entity. In such instances, the user 192 can be an agent of the entity 193, and even within a physical site of the entity 193, although that is not necessary. In embodiments, the computer system 190 or other device of the user 192 or the entity 193 are client devices for the computer system 195.

The computer system 190 may access the computer system 195 via a communication network 188, such as the internet. In particular, the entities and associated systems of FIG. 1 may communicate via physical and logical channels of the communication network 188. For example, information may be communicated as data using the Internet Protocol (IP) suite over a packet-switched network such as the Internet or other packet-switched network, which may be included as part of the communication network 188. The communication network 188 may include many different types of computer networks and communication media including those utilized by various different physical and logical channels of communication, now known or later developed. Non-limiting media and communication channel examples include one or more, or any operable combination of: fiber optic systems, satellite systems, cable systems, microwave systems, asynchronous transfer mode (“ATM”) systems, frame relay systems, radio frequency (“RF”) systems, telephone systems, cellular systems, other wireless systems, and the Internet. In various embodiments the communication network 188 can be or include any type of network, such as a local area network (LAN), a metropolitan area network (MAN), a wide area network (WAN), a private or public wireless cellular network (e.g., a fifth generation (5G) wireless network) or the internet.

Downloading or uploading may be permitted from one of these two computer systems to the other, and so on. Such accessing can be performed, for instance, with manually uploading files, like spreadsheet files, etc. Such accessing can also be performed automatically as shown in the example of FIG. 1. The computer system 190 and the computer system 195 may exchange requests and responses with each other. Such can be implemented with a number of architectures.

In one such architecture, a device remote to the service engine 183, such as computer system 190, may have a certain application (not shown) and a connector (not shown) that is a plugin that sits on top of that certain application. The connector may be able to fetch from the remote device the details required for the service desired from the OSP 198, form an object or payload 134, and then send or push a request 184 that carries the payload 134 to the service engine 183 via a service call. The service engine 183 may receive the request 184 with the payload 134. The service engine 183 may then apply digital rules 170 to the payload 134 to determine a requested resource 179 and/or prediction value 149, form a payload 137 that is an aspect of the resource 179 and/or prediction value 149, and then push, send, or otherwise cause to be transmitted a response 187 that carries the payload 137 to the connector. The connector reads the response 187, and forwards the payload 137 to the certain application.

In an alternative such architecture, a device remote to the service engine 183, such as computer system 190, may have a particular application (not shown). In addition, the computer system 195 may implement a REST (Representational State Transfer) API (Application Programming Interface) (not shown). REST or RESTful API design is designed to take advantage of existing protocols. While REST can be used over nearly any protocol, it usually takes advantage of HTTP (Hyper Text Transfer Protocol) when used for Web APIs. This alternative architecture enables the primary entity 193 to directly consume a REST API from their particular application, without using a connector. The particular application of the remote device may be able to fetch internally from the remote device the details required for the service desired from the OSP 198, and thus send or push the request 184 to the REST API. In turn, the REST API talks in background to the service engine 183. Again, the service engine 183 determines the requested resource 179, and sends an aspect of it back to the REST API. In turn, the REST API sends the response 187 that has the payload 137 to the particular application.

Moreover, in some embodiments, data from the computer system 190 and/or from the computer system 195 may be stored in an Online Processing Facility (OPF) 189 that can run software applications, perform operations, and so on. In such embodiments, requests and responses may be exchanged with the OPF 189, downloading or uploading may involve the OPF 189, and so on. In such embodiments, the computer system 190 and any devices of the OPF 189 can be considered to be remote devices, at least from the perspective of the computer system 195.

In some instances, the user 192 or the primary entity 193 may have instances of relationships with secondary entities. Only one such secondary entity 196 is shown. However, additional secondary entities may be present in various other embodiments. In this example, the primary entity 193 has a relationship instance 197 with the secondary entity 196 via an intermediary entity 160 using communication 162 between the intermediary entity 160 and the secondary entity 196. For example, the communication 162 between the intermediary entity 160 and the secondary entity 196 may be made over network 188.

In some instances, the user 192, the primary entity 193 and/or the intermediary entity 160 may have data about one or more secondary entities, for example via relationship instances of the user 192 or primary entity with the secondary entity 196. Also, the intermediary entity 160 and/or secondary entity 196 may have data about the primary entity 193, for example via relationship instances of the user 192 or primary entity 193 with the intermediary entity 160 and/or secondary entity 196. The primary entity 193, the intermediary entity 160, and/or the secondary entity 196 may be referred to as simply entities. One of these entities may have one or more attributes. Such an attribute of such an entity may be any one of its name, type of entity, a physical or geographical location such as an address, whether the entity is a lodging operator, whether the entity is an online marketplace for lodging operators (e.g., for short-term lodging operators), a contact information element, an affiliation, a characterization of another entity, a characterization by another entity, an association or relationship with another entity (general or specific instances), an asset of the entity, a declaration by or on behalf of the entity, and so on.

In embodiments, the computer system 195 receives one or more datasets. A sample received dataset 135 is shown below the line 115. The dataset 135 may be received by the computer system 195 in a number of ways. In some embodiments, one or more requests may be received by the computer system 195 via a network. In this example, a request 184 is received by the computer system 195 via the network 188. The request 184 has been transmitted by the remote computer system 190. The received one or more requests can carry payloads. In this example, the request 184 carries a payload 134. In such embodiments, the one or more payloads may be parsed by the computer system 195 to extract the dataset. In this example, the payload 134 can be parsed by the computer system 195 to extract the dataset 135. In this example the single payload 134 encodes the entire dataset 135, but that is not required. In fact, a dataset can be received from the payloads of multiple requests. In such cases, a single payload may encode only a portion of the dataset. And, of course, the payload of a single request may encode multiple datasets. Additional computers may be involved with the network 188, some beyond the control of the user 192 or OSP 198, and some within such control.

The dataset 135 has values that can be numerical, alphanumeric, Boolean, and so on, as needed for what the values characterize. For example, an identity value ID may indicate an identity of the dataset 135, so as to differentiate it from other such datasets. At least one of the values of the dataset 135 may characterize an attribute of a certain one of the entities 193 and 196, and/or the intermediary entity 160 as indicated by arrows 199. (It should be noted that the arrows 199 describe a correspondence, but not the journey of data in becoming the received dataset 135.) For instance, a value D1 may be the name of the certain entity, a value D2 may be for relevant data of the entity, and so on. Plus, an optional value B1 may be a numerical base value for an aspect of the dataset, and so on. The aspect of the dataset may be the aspect of the value that characterizes the attribute, an aspect of the reason that the dataset was created in the first place, an indication of whether the relationship instance 197 with the secondary entity 196 is via the intermediary entity 160, an indication of whether a resource associated with the relationship instance 197 is received via the intermediary entity 160, an indication of an identity or other characteristic of the intermediary entity 160, and so on. The dataset 135 may further have additional such values, as indicated by the horizontal dot-dot-dot to the right of the dataset 135. In some embodiments, each dataset, such as dataset 135 corresponds to one relationship instance. In some embodiments, the dataset 135 may correspond to a plurality of relationship instances and include such respective values for each respective relationship instance of the plurality of relationship instances. In some embodiments, the dataset 135 has values that characterize attributes of each of the primary entity 193, the secondary entity 196 and the intermediary entity 160, but that is not required. In some embodiments, the primary entity 193 may be the intermediary entity 160 or secondary entity 196 and communications described herein such as the request 184 and response 187 may be additionally or instead between the intermediary entity 160 or secondary entity 196 and the computer system 195.

In embodiments, stored digital rules 170 may be accessed by the computer system 195. These rules 170 are digital in that they are implemented for use by software. For example, these rules 170 may be implemented within programs 131 and data 138. The data portion of these rules 170 may alternately be implemented in memories in other places, which can be accessed via the network 188. These rules 170 may be accessed responsive to receiving a dataset, such as the dataset 135.

The digital rules 170 may include main rules, which can thus be accessed by the computer system 195. In this example, three sample digital main rules are shown explicitly, namely M_RULE5 175, M_RULE6 176, and M_RULE7 177. In this example, the digital rules 170 also include digital precedence rules P_RULE2 172 and P_RULE3 173, which can thus be further accessed by the computer system 195. The digital rules 170 may include additional rules and types of rules, as suggested by the vertical dot-dot-dots.

In embodiments, a certain one of the digital main rules may be identified from among the accessed stored rules by the computer system 195. In particular, values of the dataset 135 can be tested, according to arrows 171, against logical conditions of the digital main rules, as described later in this document. In this example, the certain main rule M_RULE6 176 is thus identified, which is indicated also by the beginning of an arrow 178 that is described in more detail later in this document. Identifying may be performed in a number of ways, and depending on how the digital main rules are implemented. An example is now described.

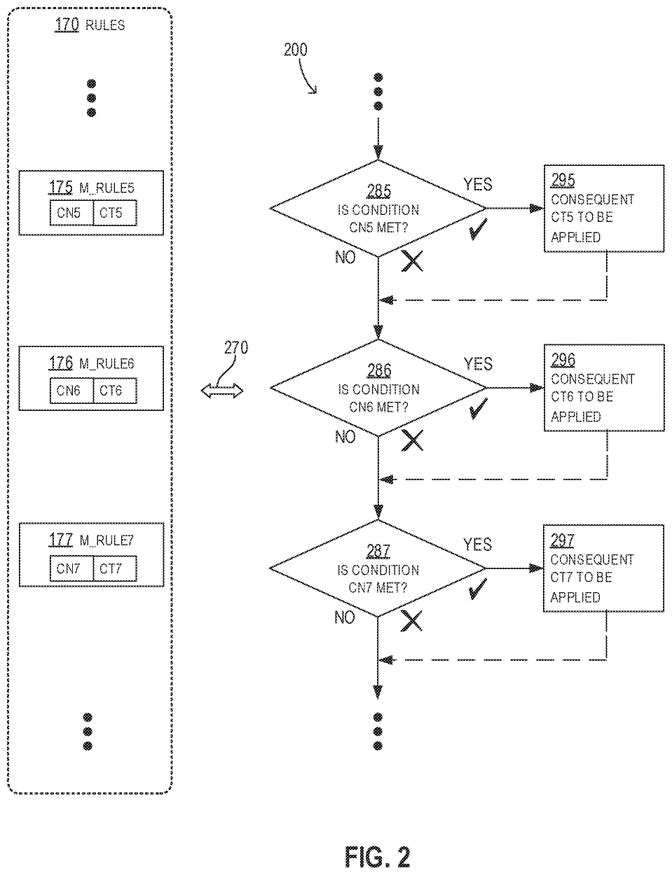

Referring now also to FIG. 2, some of the digital main rules of digital rules 170 are repeated from FIG. 1 in more detail. In addition, according to an arrow 270, these digital main rules are shown juxtaposed with a flowchart portion 200. In embodiments, some of the digital main rules can be expressed in the form of a logical “if-then” statement, such as: “if P then Q”. In such statements, the “if” part, represented by the “P”, is called the condition, and the “then” part, represented by the “Q”, is called the consequent. Therefore, at least some of the digital main rules include respective conditions and respective consequents associated with the respective conditions, respectively. And, for a certain digital main rule, if its certain condition P is met, then its certain consequent Q is what happens or becomes applied. One or more of the digital rules 170 may have more than one conditions P that both must be met, and so on. And some of these digital rules 170 may be searched for, and grouped, according first to one of the conditions, and then the other. In this example, the digital main rules M_RULE5 175, M_RULE6 176, and M_RULE7 177 of FIG. 1, include respective conditions CN5, CN6, CN7, and respective consequents CT5, CT6, CT7 associated with the respective conditions CN5, CN6, CN7, respectively.

In embodiments, therefore, identifying is performed by recognizing, by the computer system 195, that a certain condition of a certain one of the accessed digital main rules is met by one or more of the values of the dataset. An example of the operations of recognizing that a condition is met and thus identifying an applicable rule is shown by flowchart portion 200 of FIG. 2. According to successive decision diamonds 285, 286, 287, it is determined whether or not conditions CN5, CN6, CN7 are met by at least one of the values of the dataset, respectively. If the answer is NO, then execution may proceed to the next diamond. If the answer is YES then, according to operations 295, 296, 27, it is further determined that the respective consequents CT5, CT6, CT7 are to be applied, and then execution may proceed to the next diamond in the flowchart portion. A consequent that is to be applied could be, for example, flagged as TRUE.

From what was mentioned in connection with FIG. 1, the certain M_RULE6 176 was thus identified. With reference to FIG. 2, the identification may have happened at operation 286 of the flowchart portion 200, at which time it was recognized that condition CN6 was met by a value of the dataset 135. This made: the condition CN6 be the certain condition, the digital main rule M_RULE6 176 be the certain digital main rule, and the consequent CT6 be the certain consequent of the certain digital main rule M_RULE6 176. And the certain consequent CT6 is associated with the certain condition CN6, since both are included by the certain digital main rule 176. Therefore, according to operation 296, consequent CT6 is what happens or becomes applied, as described below.

A number of examples are possible for how to recognize that a certain condition of a certain digital rule is met by at least one of the values of the dataset. For instance, the certain condition could define a boundary of a region that is within a space. The region could be geometric, and be within a larger space and may include political boundaries. For example, the region could be geographic, within the space of a city, a county, a state, a country, a continent or the earth. The boundary of the region could be defined in terms of numbers according to a coordinate system within the space. In the example of geography, the boundary could be defined in terms of groups of longitude and latitude coordinates. In such embodiments, the certain condition could be met responsive to the characterized attribute of the dataset being in the space and within the boundary of the region instead of outside the boundary. For instance, the attribute could be a location of the entity, and the one or more values of the dataset 135 that characterize the location could be one or more numbers or an address, or longitude and latitude. The condition can be met depending on how the one or more values compare with the boundary. For example, the comparison may reveal that the location is in the region instead of outside the region. The comparison can be made by rendering the characterized attribute in units comparable to those of the boundary. For example, the characterized attribute could be an address that is rendered into longitude and latitude coordinates, and so on.

The above embodiments are only examples, and not limiting. For instance, the example of FIG. 2 suggests that there is a one-to-one correspondence of the conditions with the associated consequents, but that is not necessary. In fact, a single consequent may be associated with two or more conditions, and two or more consequents may be associated with a single condition. Of course, all such can be shown as additional rules, with groups of them having the same condition or consequent.

For another instance, once it is determined that a consequent is to be applied, execution may even exit the flowchart portion 200. Or, as shown, it may be determined that more than one of the digital main rules is to be applied. In particular, operation 286 may give the answer YES such that consequent CT6 is to be applied, and operation 287 may also give the answer YES such that consequent CT7 is to be applied.

Where more than one of the digital main rules are found that could be applied, there are additional possibilities. For instance, the computer system 195 of FIG. 1 may further access at least one stored digital precedence rule, such as P_RULE2 172 or P_RULE3 173. Accordingly, the certain digital main rule may be thus identified also from the digital precedence rule. In particular, the digital precedence rule may decide which one or more of the digital main rules is to be applied. To continue the previous example, if a value of the dataset 135 that characterizes a location, and the location is within multiple overlapping regions according to multiple rules, the digital precedence rule may decide that all of them are to be applied, or less than all of them are to be applied. Equivalent embodiments are also possible, where digital precedence rules are applied first to limit the iterative search of the flowchart portion 200, so as to test the applicability of fewer than all the rules according to arrows 171.

Another example for how to recognize that a certain condition of a certain digital rule is met by at least one of the values of the dataset is that the certain condition could be regarding a type of entity associated with the values of the dataset, such as whether the entity is a lodging operator or a an online marketplace for lodging operators (e.g., which may be the intermediary entity 160), a condition regarding lodging inventory and/or lodging occupancy rates for the entity or a condition regarding an amount of resources (e.g., resource 179) to be remitted to an authority associated with one or more of a plurality of domains in which the lodging stays occurred. In such embodiments, the certain condition could be met responsive to the characterized attribute of the dataset indicating whether the entity is a lodging operator or an online marketplace for lodging operators. Also or instead, the certain condition could be met responsive to lodging inventory and/or lodging occupancy rates for the entity, or an amount of resources to be remitted to an authority associated with one or more of a plurality of domains in which the lodging stays occurred, being equal to a certain value, comparing to each other in certain ways and/or meeting certain thresholds. The condition can be met depending on how the one or more values compare with each other or with individual or aggregated corresponding values of other entities with similar attributes. For example, comparing domain-specific lodging inventory data for multiple entities sharing similar attributes to lodging occupancy rates for multiple entities sharing similar attributes, as well as considering data indicative of resources received for lodging stays (some or all of such data may be generated by service engine 183 from the dataset 135 and/or other external sources), may result in a prediction value 149 being generated regarding one or more of: future lodging availability, future resources associated with future lodging stays in one or more of a plurality of domains, and/or an amount of resources recommended for one or more lodging operators to receive for providing lodging stays in one or more of a plurality of domains associated with the dataset.

In embodiments, a resource and/or a prediction value may be produced for the dataset, by the computer system 195 applying the certain consequent of the certain digital main rule. The resource and/or a prediction value can be, or be a part of, a computational result, a document, an item of value, a representation of an item of value, etc., made, created or prepared for the user 192, the primary entity 193, the secondary entity 196, the intermediary entity 160, etc., on the basis of the attribute. As such, in some embodiments, the resource and/or prediction value is produced by a determination and/or a computation. In the example of FIG. 1, a resource 179 is produced for the dataset 135, by the computer system 195 applying the certain M_RULE6 176, and in particular its certain consequent CT6, as indicated by the arrow 178. A prediction value 149 is also produced based on the dataset 135 and/or producing resource 179, by the computer system 195 applying the certain M_RULE7 177, and in particular its certain consequent CT7, as indicated by the arrow 148. In fact, sometimes applying the consequent is more simply stated as “applying the rule”.

The resource and/or prediction value may be produced in a number of ways. For example, the certain consequent can be applied to one or more of the values of the dataset 135. In some embodiments, the prediction value 149 may be produced by applying a certain consequent to one or more of the values of the dataset 135 and/or the specific data of dataset 135 on which production of resource 179 is based. For instance, one of the values of the dataset 135 can be a numerical base value, e.g. B1, that encodes an aspect of the dataset 135, as mentioned above. In such cases, applying the certain consequent may include performing a mathematical operation on the base value B1. For example, applying the certain consequent may include multiplying the base value B1 with a number indicated by the certain consequent. Such a number can be, for example, a percentage, e.g., 1.5%, 3%, 5%, and so on. Such a number can be indicated directly by the certain rule, or be stored in a place indicated by the certain rule, and so on.

As mentioned above, in some embodiments two or more digital main rules may be applied. For instance, referring again to FIG. 1, the computer system 195 may recognize that an additional condition of an additional one of the accessed digital main rules 170 is met by at least one of the values of the dataset 135. In this example there would be no digital precedence rules, or the available digital precedence rules would not preclude both the certain digital main rule and the additional digital main rule from being applied concurrently. Such an additional digital main rule would have an additional consequent.

In such embodiments, the resource and/or prediction value may be produced by the computer system applying the certain consequent and the additional consequent. For instance, where the base value B1 is used, applying the certain consequent may include multiplying the base value B1 with a first number indicated by the certain consequent, so as to compute a first product. In addition, applying the additional consequent may include multiplying the base value B1 with a second number indicated by the additional consequent, so as to compute a second product. And, the resource may be produced by summing the first product and the second product.

In embodiments, a notification, such as notification 136 and/or notification 146, can be caused to be transmitted, e.g., via the network 188, by the computer system. The notification can be about an aspect of the resource or an aspect of the prediction value 149. In the example of FIG. 1, a notification 136 and/or notification 146 can be caused to be transmitted by the computer system 195, for example as an answer or other response to the received dataset 135. In some embodiments, notification 146 can also or instead be caused to be transmitted by the computer system 195, for example as an answer or other response to data received by the computer system 195 from other external sources, alone or in combination with data from dataset 135. The notification 136 can be about an aspect of the resource 179. In particular, the notification 136 may inform about the aspect of the resource 179, namely that it has been determined, where it can be found, what it is, or at least a portion or a statistic of its content, a rounded version of it, and so on. Of course, the planning should be that the recipient of the notification 136 understands what it is being provided. The notification 146 can be about an aspect of the prediction value 146. In particular, the notification 146 may inform about the aspect of the prediction value 149, namely that it has been determined, where it can be found, what it is, or at least a portion or a statistic of its content, a rounded version of it, and so on. Of course, the planning should be that the recipient of the notification 146 understands what it is being provided.

The notification 136 and/or notification 146 can be transmitted to one of an output device and another device. The output device may be the screen of a local user or a remote user. The notification 136 and/or notification 146 may thus cause a desired image, message, or other such notification to appear on the screen, such as within a Graphical User Interface (GUI) and so on. The other device can be the remote device, from which the dataset 135 was received, as in the example of FIG. 1. In particular, the computer system 195 may cause the notification 136 and/or notification 146 to be communicated by being encoded as a payload 137, which is carried by a response 187. The response 187 may be transmitted via the network 188 responsive to the received request 184. The response 187 may be transmitted to the computer system 190, or to OPF 189, and so on. As such, the other device can be the computer system 190, or the OPF 189, or the screen 191 of the user 192, and so on. In this example, the single payload 137 encodes the entire notification 136, but that is not required. Similarly with what is written above about encoding datasets in payloads, the notification 136 and/or notification 146 instead may be provided via two or more payloads, or in other cases the notification 136 and/or notification 146, and at least one other notification, may be included in the same single payload. Along with the aspect of the resource 179 and/or prediction value 149, it can be advantageous to embed in the payload 137 the identity value (ID) and/or one or more values of the dataset 135. This will help the recipient correlate the response 187 to the request 184, and therefore match the received aspect of the resource 179 as the answer or other response to the appropriate dataset.

In an example embodiment, there may be a plurality of relationship instances between the primary entity 193 and one or more secondary entities, such as secondary entity 196. In some embodiments, such relationship instances are between the primary entity 193 and one or more secondary entities, such as secondary entity 196, via one or more intermediary entities, such as intermediary entity 160 using communication 162. Each relationship instance may be associated with one or more respective domains of a plurality of domains. Also, each relationship instance may be associated with one or more respective intermediary entities, such as intermediary entity 160, which handles or facilitates creation of the relationship instance using communication 162. For example, a resource associated with the relationship instance 197 may be received by the primary entity 193 via the intermediary entity 160. In various embodiments, a domain may be a region defined by a boundary as discussed above or may be an entity representing or otherwise associated with the region. For example, the region could be geographic, within the space of a city, a county, a state, a country, a continent or the earth. The plurality of relationship instances may result in a requirement that an electronic reporting document associated with the primary entity 193 be prepared regarding an amount of resources due to one or more of the plurality of domains, that the document be sent to one or more of the plurality of domains and that resources possibly be remitted to one or more of the plurality of domains. A domain as used herein may refer to a geographic area or to one or more authorities (or computerized systems controlled by such authorities) that set or define rules or digital rules for such a geographic area or domain as described herein. The OSP 198 may perform or facilitate such electronic actions.

For example, in one embodiment, primary entity 193 may have a relationship instance with secondary entity 196 and that particular relationship instance may be associated with one or more domains and with the particular intermediary entity 160 through which a resource associated with the relationship instance 197 was received by the primary entity 193 from the secondary entity 196. The association of the relationship instance with the one or more domains may be based on a variety of characteristics including, but not limited to: a relationship of one or more of the primary entity and secondary entity with the particular domain; a location of one or more of the primary entity and secondary entity within or associated with the particular domain; a region or location associated with one or more of the primary entity and secondary entity being within or associated with the particular domain; a previous relationship of one or more of the primary entity and secondary entity with the particular domain; a location of items associated with one or more of the primary entity and secondary entity within the particular domain; a number of relationships of one or more of the primary entity and secondary entity with the particular domain; a transfer of items associated with one or more of the primary entity and secondary entity to or from an entity within or associated with the particular domain; a transfer of data associated with one or more of the primary entity and secondary entity to or from an entity within or associated the particular domain, etc. The existence or identification of the relationship instance and/or one or more characteristics of the relationship instance may be defined or represented by values of dataset 135.

In the present example, the OSP 198 may obtain data regarding a plurality of sources and corresponding amounts of resources received from the sources for each of the plurality of relationship instances. An example of a source of resources received for a particular relationship instance may be a particular intermediary entity, such as intermediary entity 160. Another example of a source of resources received for a particular relationship instance may be the secondary entity 196 directly. Dataset 135 may include such data regarding a plurality of sources and corresponding amounts of resources received from the sources for each of the plurality of relationship instances each associated with one or more respective domains of a plurality of domains. Such data regarding the plurality of sources and corresponding amounts of resources received from the sources for each of the plurality of relationship instances may originate from primary entity 193, intermediary entity 160, secondary entity 196 and/or one or more other secondary entities.

In some embodiments, for each relationship instance of the plurality of relationship instances, the OSP 198 electronically identifies a rate to calculate an amount of resource due to one or more respective domains associated with the relationship instance based on a source of a resource received for the relationship instance and the one or more respective domains. For example, the primary entity 193 may send request 184 to the computer system 195 of OSP 198 for services that facilitate remitting resources due to one or more respective domains. The request 184 may include the existence or identification of the relationship instance and/or one or more characteristics of the relationship instance as part of payload 134. The service engine 183 may then apply digital rules 170 to the relationship instance and/or one or more characteristics of the relationship instance to identify or otherwise determine the rate to calculate an amount of resource due to one or more respective domains associated with the relationship instance.

For example, digital precedence rule P_RULE2 172 may decide that rule M_RULE5 175 is to be applied when a particular condition is met. Digital precedence rule P_RULE2 172 may include a condition that indicates if a particular relationship instance is associated with a particular domain, then rule M_RULE5 175 is to be applied. The service engine 183 may determine that the condition is met due to one or more values of dataset 135 indicating the particular relationship instance and that the particular relationship instance is associated with the particular domain. Thus, as a consequent of precedence rule P_RULE2 172, the service engine 183 applies rule M_RULE5 175. Rule M_RULE5 175 may include a condition CN5 that indicates if a particular source of the resource received for that relationship instance is associated with that particular domain, then, as consequent CT5, a particular rate is to be used to calculate an amount of resource due to that particular domain.

Referring again to FIG. 2, at decision diamond 285 it is determined that the condition CN5 is met (i.e., that the particular source of the resource received for that relationship instance is associated with that particular domain) and thus, the particular rate is used to calculate an amount of resource due to that particular domain. Thus, by applying digital rules 170, the service engine 183 identifies the rate to calculate an amount of resource due to one or more respective domains associated with the relationship instance based on a source of a resource received for the relationship instance and the one or more respective domains, and also calculates an amount of resources due to at least one respective domain associated with the relationship instance based on the identified rate. In some embodiments, this calculated amount of resources due may be included by the service engine 183 as part of the resulting requested resource 179 and/or notification 136. The service engine 183 may then form a payload 137 that is an aspect of the resource 179, and then push, send, or otherwise cause to be transmitted a response 187 that carries the payload 137 to a device remote to the service engine 183, such as computer system 190, a device of secondary entity 196 or another secondary entity. Digital rules 170 may include multiple different digital rules for each type of relationship instance and different domains.

The service engine 183 may then, for each domain of the plurality of domains, aggregate a total amount of resources due to the domain based on the calculated amount of resources due for each relationship instance associated with the domain and electronically prepare a reporting document indicating the total amount of resources due to the domain and an amount of resources already remitted to the domain for the plurality relationship instances. The service engine 183 may then push, transmit or otherwise cause to be sent the reporting document to a system of the domain via network 188 and/or the computer system 190 of the primary entity 193. For example, the prepared reporting document may comprise or be included by the service engine 183 as part of the resulting requested resource 179 and/or notification 136 and the system of the domain to which the reporting document is sent may be a secondary entity accessible via network 188 other than secondary entity 196.

According to one or more of the digital rules 170, the service engine 183 may then, for each lodging operator of a plurality of lodging operators, electronically determine lodging inventory data of the lodging operator in the domain based lodging operator data, such as each relationship instance (e.g., lodging stay) associated with the domain, which may be part of other lodging operator data automatically extracted by the service engine 183 from the reporting document that has already been prepared or from data to be included in the reporting document. The service engine 183 may then electronically aggregate the determined lodging inventory data of each a plurality of lodging operators in one or more of a plurality of domains; electronically generate domain-specific lodging inventory data for each domain of the one or more of the plurality of domains based on the aggregated lodging inventory data; electronically generate, based on the lodging stay data and the domain-specific lodging inventory data, lodging occupancy rates of lodging inventory for the one or more of the plurality of domains; and electronically determine a prediction value 149 of future resources associated with future lodging stays in one or more of the plurality of domains. In some embodiments, the service engine 183 may electronically aggregate the determined lodging inventory data and/or generate the lodging occupancy rates according to or otherwise based on the source of resources received for a particular relationship instance (e.g., a lodging stay). For example the source may be a particular intermediary entity (e.g., a lodging marketplace operator). The prediction value 149 may be determined based on the generated domain-specific lodging inventory data and the generated lodging occupancy rates. The service engine 183 may then push, transmit or otherwise cause to be sent the prediction value 149 (e.g., via notification 146) to the computer system 190 of the primary entity 193 or a computer system of the intermediary entity 160. For example, the prediction value 149 may comprise or be included by the service engine 183 as part of the resulting notification 146 and the system to which the prediction value 149 is sent may be that of the primary entity 193 or intermediary entity 160 accessible via network 188.

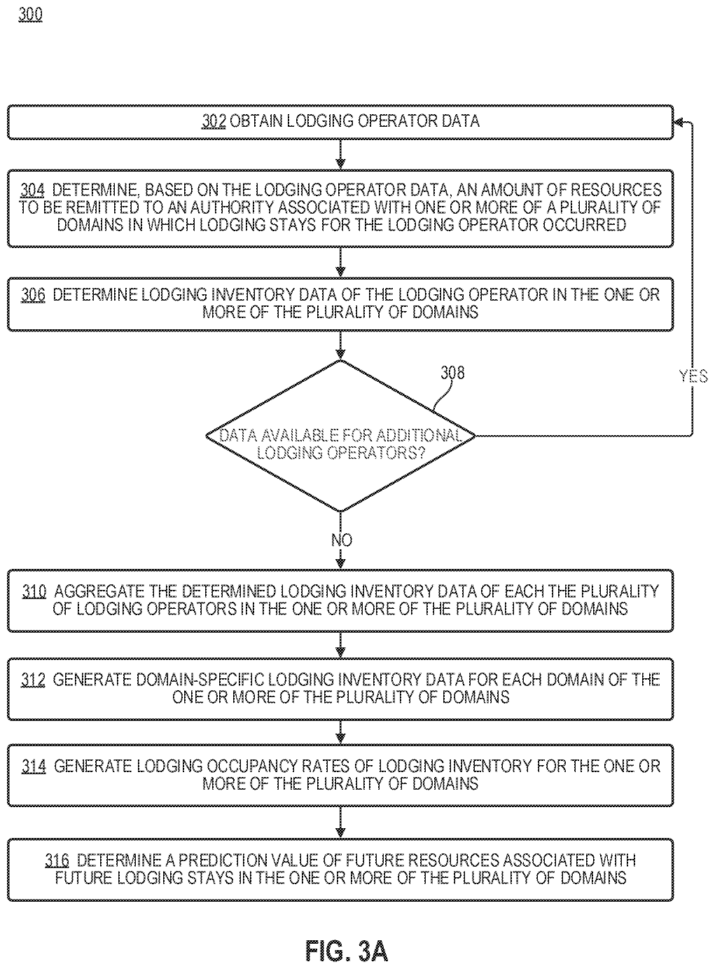

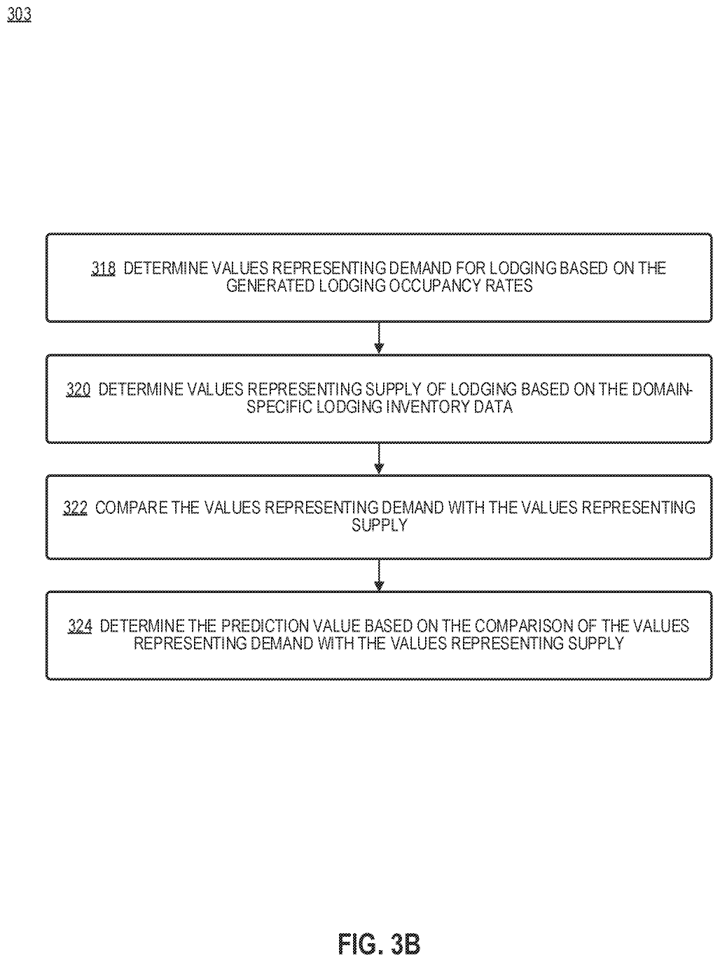

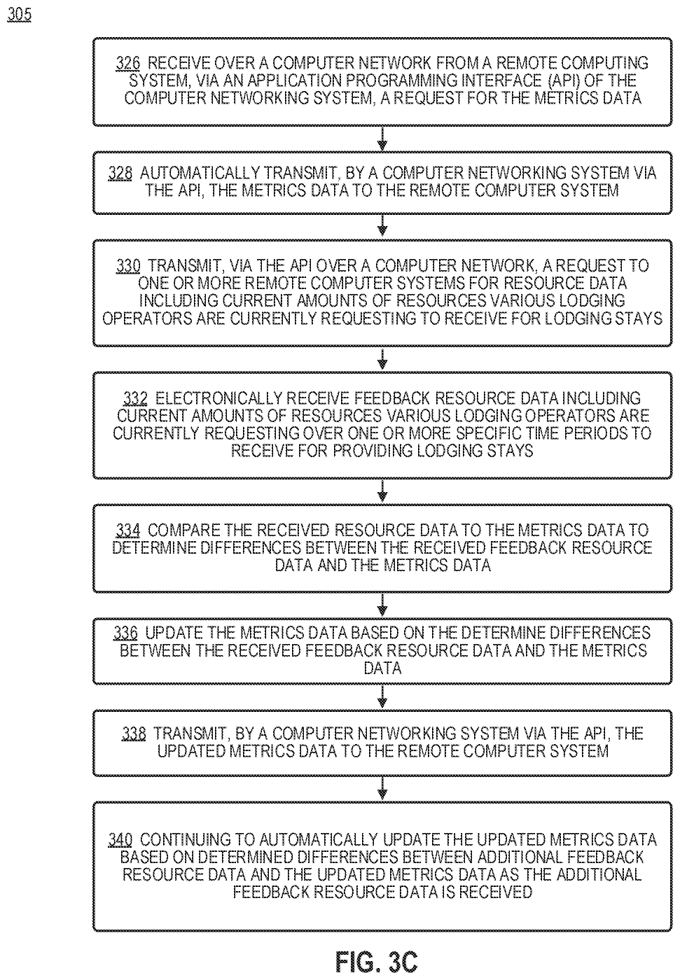

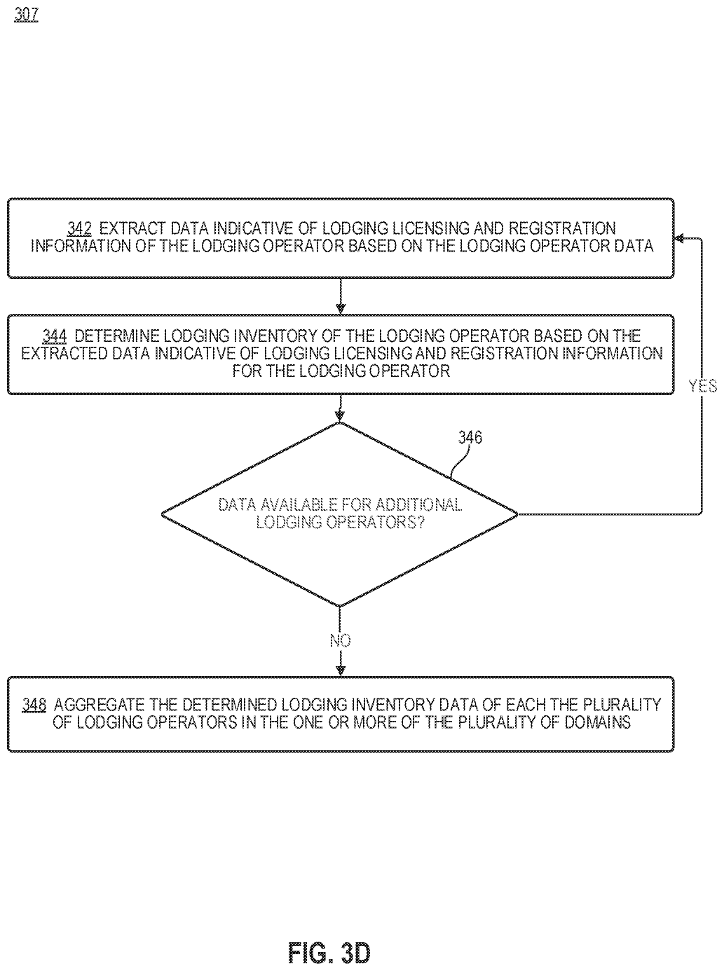

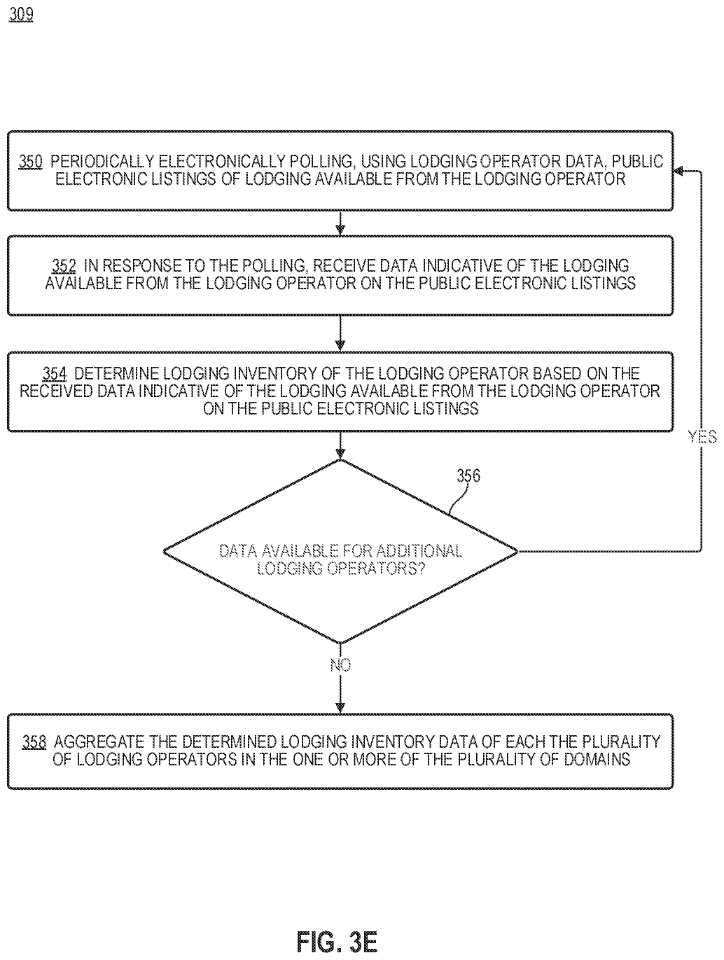

FIG. 3A is a flowchart for illustrating a sample method 300 according to embodiments of the present disclosure.

At 302, the OSP 198 electronically obtains lodging operator data. The lodging operator data includes lodging stay data regarding lodging stays associated with the lodging operator and other data regarding the lodging operator.

At 304, the OSP 198 electronically determines, based on the lodging operator data, an amount of resources to be remitted to an authority associated with one or more of a plurality of domains in which the lodging stays occurred.

At 306, the OSP 198 electronically determines lodging inventory data of the lodging operator in the one or more of the plurality of domains based on the lodging operator data.

At 308, the OSP 198 determines whether data is available for additional lodging operators of a plurality of lodging operators. For example, the plurality of lodging operators may be lodging operators for which the OSP 198 already provides electronic services, such as computations of resources to be remitted to an authority associated with one or more of a plurality of domains in which lodging stays associated with the lodging operator occurred. If the OSP 198 determines data is available for additional lodging operators, then the method 300 proceeds back to 302 to process the data for the additional lodging operator. If the OSP 198 determines data is not available for additional lodging operators, then the method 300 proceeds to 310.

At 310, the OSP 198 electronically aggregates the determined lodging inventory data of each the plurality of lodging operators in the one or more of the plurality of domains.

At 312, the OSP 198 electronically generates domain-specific lodging inventory data for each domain of the one or more of the plurality of domains based on the aggregated lodging inventory data.

At 314, the OSP 198 electronically generates, based on the lodging stay data and the domain-specific lodging inventory data, lodging occupancy rates of lodging inventory for the one or more of the plurality of domains.

At 316, the OSP 198 electronically determines a prediction value of future resources associated with future lodging stays in the one or more of the plurality of domains. The prediction value may be determined based on the generated domain-specific lodging inventory data and the generated lodging occupancy rates. Electronically determining the prediction value may include comparing the generated domain-specific lodging inventory data to the generated lodging occupancy rates, and then determining the prediction value based on the comparison of the domain-specific lodging inventory data to the generated lodging occupancy rates. In some embodiments, the prediction value represents an amount of resources recommended for one or more lodging operators of the plurality of lodging operators to receive for providing lodging stays in the one or more of the plurality of domains.

In some embodiments, for each lodging operator of the plurality of lodging operators, the OSP 198 electronically remits, on behalf of the lodging operator, to a computer system of the authority, the amount of resources to be remitted to the authority by electronically pulling the amount of resources from an account of the lodging operator.

The OSP 198 may use the prediction value to generate a recommendation value representing an amount of resources recommended for one or more lodging operators of the plurality of lodging operators to receive for providing lodging stays in the one or more of the plurality of domains. The OSP 198 may then transmit the recommendation value to the one or more of the lodging operators. In some embodiments, OSP 198 may use the prediction value to generate metrics data for recommending an amount of resources one or more lodging operators of the plurality of lodging operators to receive for providing lodging stays in the one or more of the plurality of domains. The OSP 198 may then transmit the recommendation value to the one or more of the lodging operators

In various embodiments, the method 300 is implemented by the service engine 183 of the OSP 198 executing software code based on digital rules 170. For example the decision at 308 may be made according to decision diamonds, such as decision diamond 287 of digital main rule M_RULE7 177. Decision diamond 287 may determine whether the condition (that data is available for additional lodging operators) is met and consequent CT7 may be for the method 300 to proceed back to 302 to process the data for the additional lodging operator and electronically obtain lodging operator data for that additional lodging operator.

FIG. 3B is a flowchart for illustrating a sample method 303 for determining a prediction value according to embodiments of the present disclosure.

At 318, the OSP 198 determines values representing demand for lodging in the in the one or more of the plurality of domains based on the generated lodging occupancy rates;

At 320 the OSP 198 determines values representing supply of lodging in the in the one or more of the plurality of domains based on the domain-specific lodging inventory data.

At 322 the OSP 198 compares the values representing demand with the values representing supply.

At 324 the OSP 198 determines the prediction value based on the comparison of the values representing demand with the values representing supply.

FIG. 3C is a flowchart for illustrating a sample method 305 involving continuing to automatically update metrics data based on determined differences between additional feedback resource data and the updated metrics data according to embodiments of the present disclosure.

At 326, the OSP 198 receives, by a computer networking system over a computer network from a remote computing system, via an application programming interface (API) of the computer networking system, a request for the metrics data.

At 328, the OSP 198, in response to receiving the request via the API of the computer networking system, automatically transmits, by a computer networking system via the API, the metrics data to the remote computer system.

At 330, the OSP 198 transmits, via the API over a computer network, a request to one or more remote computer systems for resource data including current amounts of resources various lodging operators are currently requesting to receive for lodging stays in the one or more of the plurality of domains

At 332 the OSP 198, in response to transmitting the request via the API, electronically receives feedback resource data including current amounts of resources various lodging operators are currently requesting over one or more specific time periods to receive for providing lodging stays in the one or more of the plurality of domains.

At 334 the OSP 198 compares the received resource data to the metrics data to determine differences between the received feedback resource data and the metrics data.

At 336 the OSP 198 updates the metrics data based on the determine differences between the received feedback resource data and the metrics data.

At 338 the OSP 198, in response to updating the metrics data, automatically transmits, by a computer networking system via the API, the updated metrics data to the remote computer system.

At 340 the OSP 198 continues to automatically update, by a computer networking system, the updated metrics data based on determined differences between additional feedback resource data and the updated metrics data as the additional feedback resource data is received to increase accuracy of the metrics data.

FIG. 3D is a flowchart for illustrating a sample method 307 for determining lodging inventory data according to embodiments of the present disclosure.

At 342 the OSP 198 extracts data indicative of lodging licensing and registration information of the lodging operator based on the lodging operator data.

At 342 the OSP 198 determines lodging inventory of the lodging operator based on the extracted data indicative of lodging licensing and registration information for the lodging operator.

At 346 the OSP 198 determines whether data is available for additional lodging operators of a plurality of lodging operators. For example, the plurality of lodging operators may be lodging operators for which the OSP 198 already provides electronic services, such as computations of resources to be remitted to an authority associated with one or more of a plurality of domains in which lodging stays associated with the lodging operator occurred. If the OSP 198 determines data is available for additional lodging operators, then the method 307 proceeds back to 342 to process the data for the additional lodging operator. If the OSP 198 determines data is not available for additional lodging operators, then the method 307 proceeds to 348.

At 348 the OSP 198 electronically aggregates the determined lodging inventory data of each the plurality of lodging operators in the one or more of the plurality of domains.

FIG. 3E is a flowchart for illustrating a sample method 309 for determining lodging inventory data based on received data indicative of lodging available from the lodging operator on public electronic listings according to embodiments of the present disclosure.

At 350 the OSP 198 periodically electronically polls, using the lodging operator data, public electronic listings of lodging available from the lodging operator.

At 352 the OSP 198 in response to the electronically polling the public electronic listings, receives data indicative of the lodging available from the lodging operator on the public electronic listings.

At 354 the OSP 198 determines lodging inventory of the lodging operator additionally based on the received data indicative of the lodging available from the lodging operator on the public electronic listings.

At 356 the OSP 198 determines whether data is available for additional lodging operators of a plurality of lodging operators. For example, the plurality of lodging operators may be lodging operators for which the OSP 198 already provides electronic services, such as computations of resources to be remitted to an authority associated with one or more of a plurality of domains in which lodging stays associated with the lodging operator occurred. If the OSP 198 determines data is available for additional lodging operators, then the method 309 proceeds back to 350 to process the data for the additional lodging operator. If the OSP 198 determines data is not available for additional lodging operators, then the method 309 proceeds to 358.

At 358 the OSP 198 electronically aggregates the determined lodging inventory data of each the plurality of lodging operators in the one or more of the plurality of domains.

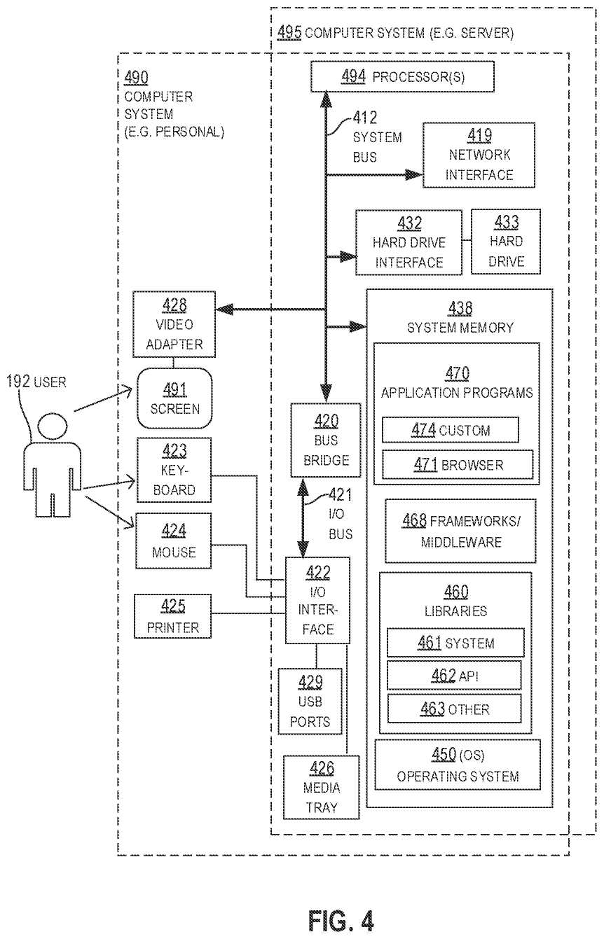

FIG. 4 is a block diagram showing additional components of sample computer systems according to embodiments of the present disclosure. FIG. 4 shows details for a sample computer system 495 and for a sample computer system 490. The computer system 495 may be a server, while the computer system 490 may be a personal device, such as a personal computer, a desktop computer, a personal computing device such as a laptop computer, a tablet computer, a mobile phone, and so on. Either type may be used for the computer system 195 and 190 of FIG. 1, a computer system that is part of OPF 189 and/or a computer system that is part of any entity or system shown in any of the Figures of the present disclosure.

The computer system 495 and the computer system 490 have similarities, which FIG. 4 exploits for purposes of economy in this document. It will be understood, however, that a component in the computer system 495 may be implemented differently than the same component in the computer system 490. For instance, a memory in a server may be larger than a memory in a personal computer, and so on. Similarly, custom application programs 474 that implement embodiments may be different, and so on.

The computer system 495 includes one or more processors 494. The processor(s) 494 are one or more physical circuits that manipulate physical quantities representing data values. The manipulation can be according to control signals, which can be known as commands, op codes, machine code, etc. The manipulation can produce corresponding output signals that are applied to operate a machine. As such, one or more processors 494 may, for example, include a Central Processing Unit (CPU), a Reduced Instruction Set Computing (RISC) processor, a Complex Instruction Set Computing (CISC) processor, a Graphics Processing Unit (GPU), a Digital Signal Processor (DSP), a Field-Programmable Gate Array (FPGA), an Application Specific Integrated Circuit (ASIC), any combination of these, and so on. A processor may further be a multi-core processor having two or more independent processors that execute instructions. Such independent processors are sometimes called “cores”.

A hardware component such as a processor may also include programmable logic or circuitry that is temporarily configured by software to perform certain operations. For example, a hardware component may include software executed by a general-purpose processor or another type of programmable processor. Once configured by such software, hardware components become specific specialized machines, or specific specialized components of a machine, uniquely tailored to perform the configured functions and are no longer general-purpose processors. It will be appreciated that the decision to implement a hardware component mechanically, in dedicated and permanently configured circuitry, or in temporarily configured circuitry (e.g., configured by software) may be driven by cost and time considerations.

As used herein, a “component” may refer to a device, physical entity or logic having boundaries defined by function or subroutine calls, branch points, Application Programming Interfaces (APIs), or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. The hardware components depicted in the computer system 495, or the computer system 490, are not intended to be exhaustive. Rather, they are representative, for highlighting essential components that can be used with embodiments.

The computer system 495 also includes a system bus 412 that is coupled to the processor(s) 494. The system bus 412 can be used by the processor(s) 494 to control and/or communicate with other components of the computer system 495.

The computer system 495 additionally includes a network interface 419 that is coupled to system bus 412. Network interface 419 can be used to access a communications network, such as the network 188. Network interface 419 can be implemented by a hardware network interface, such as a Network Interface Card (NIC), wireless communication components, cellular communication components, Near Field Communication (NFC) components, Bluetooth® components such as Bluetooth® Low Energy, Wi-Fi® components, etc. Of course, such a hardware network interface may have its own software, and so on.

The computer system 495 also includes various memory components. These memory components include memory components shown separately in the computer system 495, plus cache memory within the processor(s) 494. Accordingly, these memory components are examples of non-transitory machine-readable media. The memory components shown separately in the computer system 495 are variously coupled, directly or indirectly, with the processor(s) 494. The coupling in this example is via the system bus 412.

Instructions for performing any of the methods or functions described in this document may be stored, completely or partially, within the memory components of the computer system 495, etc. Therefore, one or more of these non-transitory computer-readable media can be configured to store instructions which, when executed by one or more processors 494 of a host computer system such as the computer system 495 or the computer system 490, can cause the host computer system to perform operations according to embodiments. The instructions may be implemented by computer program code for carrying out operations for aspects of this document. The computer program code may be written in any combination of one or more programming languages, including an object-oriented programming language such as Java, Smalltalk or the like, and/or conventional procedural programming languages, such as the “C” programming language or similar programming languages such as C++, C Sharp, etc.

The memory components of the computer system 495 include a non-volatile hard drive 433. The computer system 495 further includes a hard drive interface 432 that is coupled to the hard drive 433 and to the system bus 412.

The memory components of the computer system 495 include a system memory 438. The system memory 438 includes volatile memory including, but not limited to, cache memory, registers and buffers. In embodiments, data from the hard drive 433 populates registers of the volatile memory of the system memory 438.

In some embodiments, the system memory 438 has a software architecture that uses a stack of layers, with each layer providing a particular functionality. In this example the layers include, starting from the bottom, an Operating System (OS) 450, libraries 460, frameworks/middleware 468 and application programs 470, which are also known as applications 470. Other software architectures may include less, more or different layers. For example, a presentation layer may also be included. For another example, some mobile or special purpose operating systems may not provide a frameworks/middleware 468.

The OS 450 may manage hardware resources and provide common services. The libraries 460 provide a common infrastructure that is used by the applications 470 and/or other components and/or layers. The libraries 460 provide functionality that allows other software components to perform tasks more easily than if they interfaced directly with the specific underlying functionality of the OS 450. The libraries 460 may include system libraries 461, such as a C standard library. The system libraries 461 may provide functions such as memory allocation functions, string manipulation functions, mathematical functions, and the like.

In addition, the libraries 460 may include API libraries 462 and other libraries 463. The API libraries 462 may include media libraries, such as libraries to support presentation and manipulation of various media formats such as MPEG4, H.264, MP3, AAC, AMR, JPG, and PNG. The API libraries 462 may also include graphics libraries, for instance an OpenGL framework that may be used to render 2D and 3D in a graphic content on the screen 491. The API libraries 462 may further include database libraries, for instance SQLite, which may support various relational database functions. The API libraries 462 may additionally include web libraries, for instance WebKit, which may support web browsing functionality, and also libraries for applications 470.

The frameworks/middleware 468 may provide a higher-level common infrastructure that may be used by the applications 470 and/or other software components/modules. For example, the frameworks/middleware 468 may provide various Graphic User Interface (GUI) functions, high-level resource management, high-level location services, and so forth. The frameworks/middleware 468 may provide a broad spectrum of other APIs that may be used by the applications 470 and/or other software components/modules, some of which may be specific to the OS 450 or to a platform.

The application programs 470 are also known more simply as applications and apps. One such app is a browser 2771, which is a software that can permit the user 192 to access other devices in the internet, for example while using a Graphic User Interface (GUI). The browser 2771 includes program modules and instructions that enable the computer system 495 to exchange network messages with a network, for example using Hypertext Transfer Protocol (HTTP) messaging.

The application programs 470 may include one or more custom applications 474, made according to embodiments. These can be made so as to cause their host computer to perform operations according to embodiments disclosed herein. Of course, when implemented by software, operations according to embodiments disclosed herein may be implemented much faster than may be implemented by a human mind if they can be implemented in the human mind at all; for example, tens or hundreds of such operations may be performed per second according to embodiments, which is much faster than a human mind can do. Such speed of operations, and thus the use of such computing systems and networks, are integral to the embodiments described herein because such operations would be practically useless unless they are able to be applied to hundreds or thousands of computer network clients simultaneously or concurrently across computer networks and to the vast volumes of data that change in real-time provided by such computer network clients. Implementing a practical application of the embodiments described herein to hundreds or thousands of computer network clients simultaneously or concurrently across computer networks on which they operate and to the vast volumes of data that change in real-time provided by such computer network clients is impossible to do in the human mind.

Other such applications 470 may include a contacts application, a book reader application, a word processing application, a location application, a media application, a messaging application, and so on. Applications 470 may be developed using the ANDROID™ or IOS™ Software Development Kit (SDK) by an entity other than the vendor of the particular platform, and may be mobile software running on a mobile operating system such as IOS™ ANDROID™, WINDOWS® Phone, or other mobile operating systems. The applications 470 may use built-in functions of the OS 450, of the libraries 460, and of the frameworks/middleware 468 to create user interfaces for the user 192 to interact with.

The computer system 495 moreover includes a bus bridge 420 coupled to the system bus 412. The computer system 495 furthermore includes an input/output (I/O) bus 421 coupled to the bus bridge 420. The computer system 495 also includes an I/O interface 422 coupled to the I/O bus 421.

For being accessed, the computer system 495 also includes one or more Universal Serial Bus (USB) ports 429. These can be coupled to the I/O interface 422. The computer system 495 further includes a media tray 426, which may include storage devices such as CD-ROM drives, multi-media interfaces, and so on.

The computer system 490 may include many components similar to those of the computer system 495, as seen in FIG. 4. In addition, a number of the application programs may be more suitable for the computer system 490 than for the computer system 495.

The computer system 490 further includes peripheral input/output (I/O) devices for being accessed by a user more routinely. As such, the computer system 490 includes a screen 491 and a video adapter 428 to drive and/or support the screen 491. The video adapter 428 is coupled to the system bus 412.

The computer system 490 also includes a keyboard 423, a mouse 424, and a printer 425. In this example, the keyboard 423, the mouse 424, and the printer 425 are directly coupled to the I/O interface 422. Sometimes this coupling is wireless or may be via the USB ports 429.

In this context, “machine-readable medium” refers to a component, device or other tangible media able to store instructions and data temporarily or permanently and may include, but is not be limited to: a thumb drive, a hard disk, random-access memory (RAM), read-only memory (ROM), buffer memory, flash memory, optical media, magnetic media, cache memory, an Erasable Programmable Read-Only Memory (EPROM), an optical fiber, a portable digital versatile disc (DVD), an optical storage device, a magnetic storage device, or any suitable combination of the foregoing. The machine that would read such a medium includes one or more processors 494.

The term “machine-readable medium” should be taken to include a single medium or multiple media (e.g., a centralized or distributed database, or associated caches and servers) able to store instructions that a machine such as a processor can store, erase, or read. The term “machine-readable medium” shall also be taken to include any medium, or combination of multiple media, that is capable of storing instructions (e.g., code) for execution by a machine, such that the instructions, when executed by one or more processors of the machine, cause the machine to perform any one or more of the methods described herein. Accordingly, instructions transform a general or otherwise generic, non-programmed machine into a specialized particular machine programmed to carry out the described and illustrated functions in the manner described.

A computer readable signal traveling from, to, and via these components may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

### Operational Examples—Use Cases

The above-mentioned embodiments have one or more uses. Aspects presented below may be implemented as was described above for similar aspects. (Some, but not all, of these aspects have even similar reference numerals.)

As an example use case, determining what prices to charge for short-term lodging rentals is difficult or impossible for computerized systems of many lodging operators, such as those of rental by owner (RBO) and small-scale property managers. As a technical solution to this technical problem, the lodging data and analysis engine 543 of the OSP 598 more accurately and efficiently determines such lodging prices and thus optimizes revenue using the most “real-time” lodging data possible, including real-time transaction data, tax returns prepared using data generated by tax engine 583 and an automated feedback loop from listing sites, such as those of lodging market entities (e.g., lodging marketplace entity 560). Also, data indicative of return on investment from using lodging marketplace entities, such as lodging marketplace entity 560 is uncertain (e.g., listing on AirBnB, VRBO and other marketplaces/rental platforms). As a solution to this technical problem, the lodging data and analysis engine 543 aggregates data on the remittance of mixed tax liabilities (e.g., lodging tax liability of the lodging operator 593 and lodging tax liability of the lodging marketplace entity 560 for a particular property generated by tax engine 583) for a plurality of lodging operators an lodging marketplace entities to highlight the percentage of bookings obtained from a given lodging marketplace entity for a given property, a given lodging operator, and/or given geographic area. Property owners, such as lodging operator 593 then determine whether the return on investment from listing using a given lodging marketplace entity is worth-while.

Another technical problem is that real estate investors and financiers often depend on lagging data to make investment decisions. The technical solution to this technical problem is that the lodging data and analysis engine 543 electronically generates and provides in real time a continuously updated data stream that includes an index that measures the economic health of the short-term rental market by locality, and electronically provides predictions regarding the success of listing property on an online marketplace based on anonymized tax return data generated by tax engine 583 for hundreds or thousands of short term rental properties, which is more accurate and up-to-date than other data sources providing outdated or inaccurate data. Another technical problem is that governments do not have accurate and reliable data on which to optimize their tax policy on short term rental property transactions. As a technical solution to this technical problem, lodging data and analysis engine 543 electronically generates and provides in real time a continuously updated data stream that includes comparisons of aggregated lodging tax return data generated from tax engine 583 for a plurality of lodging operators and/or lodging marketplace entities against short-term rental licensing and/or registration data (which may be indicative of supply) for a plurality of lodging operators for a plurality of different domains (e.g., geographical areas), enabling computerized governmental systems to analyze the impact of tax rates and compliance requirements on their revenue streams from short term rentals by analyzing supply and demand within a given market.

In an example embodiment, the lodging data and analysis engine 543 analyzes supply and demand within a short-term lodging rental market by electronically comparing aggregated lodging tax return data generated from tax engine 583 for a plurality of lodging operators and/or lodging marketplace entities against short-term rental licensing and/or registration data for a plurality of lodging operators for a plurality of different domains (e.g., geographical areas). The lodging data and analysis engine 543 may also assess the return on investment for listing a particular rental property on an online marketplace using mixed lodging tax liability data (e.g., lodging tax liability of the lodging operator 593 and lodging tax liability of the lodging marketplace entity 560 generated by tax engine 583 for individual properties) appearing on a lodging tax return prepared based on data generated by tax engine 583. The lodging data and analysis engine 543 of the OSP 598 compares income and rental data electronically received from lodging operators, such as lodging operator 593 and/or from lodging marketplace entities, such as lodging marketplace entity 560 (e.g., AirBnB, VRBO, etc.) to lodging operator license and lodging operator registration data electronically received from the lodging operator 593, set of tax authorities 580 and/or from other electronic sources of publicly available information to determine lodging rental occupancy rates relative to lodging rental inventory. In some embodiments, the income and rental data is electronically received by the lodging data and analysis engine 543 extracting lodging tax return data generated by tax engine 583. In various embodiments, the lodging data and analysis engine 543 uses this electronic determination of lodging rental occupancy rates relative to lodging rental inventory to electronically provide dynamic pricing recommendations over network 188 for short term rentals (e.g., via automated API operations), electronically generate and provide an index that measures the economic health of the short-term rental market by locality, and electronically provide predictions regarding the success of listing property on an online marketplace based on the determined supply and demand.

The electronic determination by the OSP 598 of lodging rental occupancy rates relative to lodging rental inventory may be performed in real-time or near real-time as hundreds or thousands lodging transactions 597 occur (which is impossible to perform in the human mind) and are then automatically communicated via network 188 from the lodging operator 593 to the computer system 595 implementing the lodging data and analysis engine 543. In other embodiments, lodging operators, such as lodging operator 593 and/or lodging marketplace entities, such as lodging marketplace entity 560, log in to the OSP 598 and report their rental revenue data represented by transaction data 597 for the month, quarter, half year, full year, or other period (depending on the taxing jurisdiction(s) of the property) such that electronic and automated tax computations and other services may be performed by tax engine 583.

The electronic determination of lodging rental occupancy rates relative to lodging rental inventory by the OSP 598 may be performed automatically based on and in response to lodging operators, such as lodging operator 593 and/or lodging marketplace entities, such as lodging marketplace entity 560, logging in to the OSP 598 and reporting such data. Such reported rental revenue data for hundreds or thousands of lodging operators may be automatically used by the lodging data and analysis engine 543 to electronically determine the lodging rental occupancy rates relative to lodging rental inventory for hundreds or thousands of lodging operators and their corresponding properties simultaneously or concurrently (which is impossible to do in the human mind) to provide a more accurate and efficient snapshot of the current state of the short term rental market in a given domain (e.g., geographical area) and transmit lodging pricing recommendations more accurately and efficiently over network 188 simultaneously or concurrently to hundreds or thousands of remote computer network clients, thus increasing the speed, efficiency and accuracy of the computerized automated enterprise resource planning (ERP) technology and networks. In some embodiments, the lodging data and analysis engine 543 is a dynamic lodging pricing engine that uses lodging tax return data generated by tax engine 583, in concert with a real-time feedback loop (e.g., from data automatically scraped from lodging operator and/or lodging marketplace web sites or other data sources), to optimize prices for short term lodging rentals.

Thus, the systems and methods described herein for automated actions for dynamic lodging resource prediction improves the functioning of computer or other hardware, such as by reducing the processing, storage, and/or data transmission resources needed to perform various tasks, including lodging resource prediction, thereby enabling the tasks to be performed by less capable, capacious, and/or expensive hardware devices, and/or be performed with less latency, and/or preserving more of the conserved resources for use in performing other tasks or additional instances of the same task.

Operational examples and sample use cases are possible where the attribute of an entity in a dataset is any one of: the entity's name; type of entity; a physical location such as an address; a contact information element; transactions of the entity; an identifier of a specific source of revenue received for a transaction of the entity; characteristics of transactions of the entity; licensure and/or or registration of the entity and/or products or services the entity produces, sells, stores and/or transfers; products or services produced, sold, stored and/or transferred by the entity; types of products or services produced, sold, stored and/or transferred by the entity; a location to which products are sent, shipped or transferred; a location from which products are received; a location of a property owned by the entity; a location of a property owned by the entity within a particular region of other domain; an affiliation; a characterization of another entity; a characterization by another entity; an association or relationship with another entity (general or specific instances); an asset of the entity; a declaration by or on behalf of the entity; and so on. Different resources may be produced in such instances, and so on.

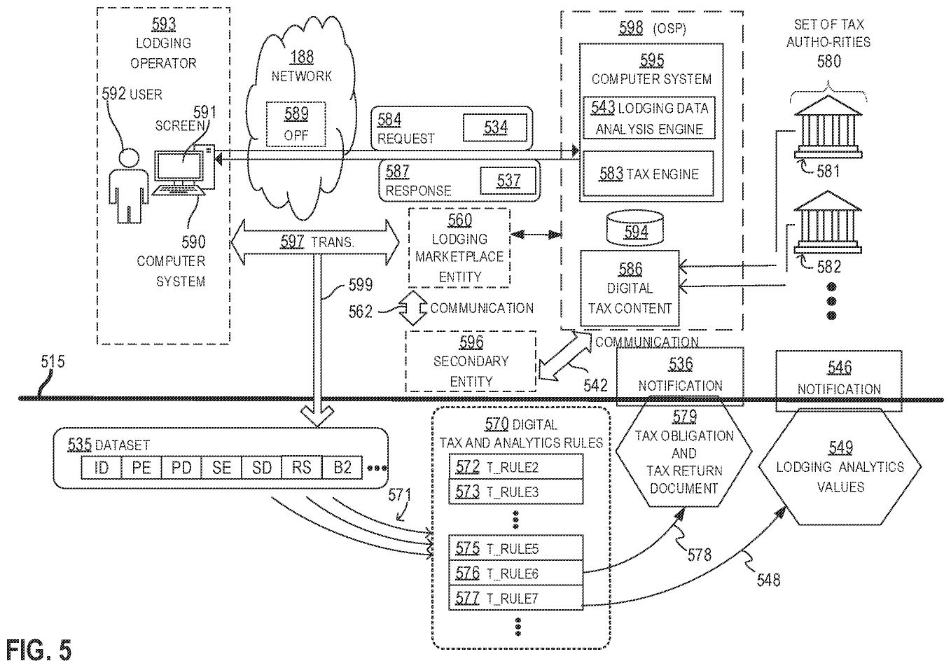

FIG. 5 is diagram for an operational example and use case where the resource 579 includes a tax obligation of a lodging operator 593, a lodging marketplace entity 560 and/or a secondary entity 596, due to a transaction 597. The resource 579 may also include the preparation and sending of an associated tax return document for the transaction 597. In the present case, the transaction is for a paid lodging stay for a person or group of people at a property owned or controlled by the lodging operator 593. The person or group of people may be secondary entity 596 and/or the lodging stay may be paid for by secondary entity 596. In the present example, the transaction 597 for the lodging stay may be made via a lodging marketplace entity 560 that handles the transaction 597 for the lodging stay between the lodging operator 593 and the secondary entity 596 via communication 562 by the lodging marketplace entity 560 with the secondary entity 596. The transaction 597 may include some or all of the data comprising the communication 562 between the lodging marketplace entity 560 and the secondary entity 596. For example, values that characterize attributes of the transaction 597 may be extracted from the communication 562 such as price, fees and/or or rate for the paid lodging stay; taxes for the paid lodging stay; address or location of the lodging; number of days—or nights—of the paid lodging stay; accommodations or services included in the paid lodging stay; identification of the lodging operator 593, secondary entity 596 and/or lodging marketplace entity 560; a contract or agreement regarding the paid lodging stay; a contract or agreement regarding collection or remitting of taxes for the paid lodging stay; other terms of the paid lodging stay; etc. In some embodiments, the communication 562 may be made via network 188. In some instances, some or all of the data comprising the communication 562 may be sent directly to the OSP 598 from the lodging marketplace entity as part of dataset 535. In various embodiments, the lodging operator 593 may also or instead book lodging stays for and transact directly with occupants, such as secondary entity 596, for lodging stays at the same or different properties. In such embodiments, the transaction 597 would be directly between the lodging operator 593 and the secondary entity 596 instead of being made via the lodging marketplace entity 560 using communication 562 as shown in FIG. 5. Prediction values, such as lodging analytics values 549 are generated by the lodging data and analysis engine 543 based on the resource 579.

It will be recognized that aspects of FIG. 5 have similarities with aspects of FIG. 1. Portions of such aspects may be implemented as described for analogous aspects of FIG. 1. In particular, a thick line 515 separates FIG. 5, although not completely or rigorously, into a top portion and a bottom portion. Above the line 515 the emphasis is mostly on entities, components, their relationships, and their interactions, while below it the emphasis is mostly processing of data that takes place often within one or more of the components above the line 515.

Above the line 515, a computer system 595 is shown, which is used to help customers, such as a user 592, with tax compliance. Further in this example, the computer system 595 is part of an OSP 598 that is implemented as a Software as a Service (SaaS) provider, for being accessed by the user 592 online. Alternately, the functionality of the computer system 595 may be provided locally to a user.

The user 592 may be standalone. The user 592 may use a computer system 590 that has a screen 591. In embodiments, the user 592 and the computer system 590 are considered part of the lodging operator 593, which is also known as entity 593. The lodging operator 593 can be a business, such as a seller of items, a reseller, a buyer, and so on. In this present case, the lodging operator 593 is a lodging operator, which is an individual or business that rents a short-term rental or vacation rental to another entity, such as, for example, secondary entity 596. In such instances, the user 592 can be an employee, a contractor, or otherwise an agent of the entity 593. In use cases, the entity 593 is a seller (e.g., of right or limited license to use particular lodging for a limited time), the secondary entity 596 is a buyer (e.g., of the right or limited license to use the particular lodging for a limited time) and together they are performing the buy-sell transaction 597. The buy-sell transaction 597 may involve an operation, such as an exchange of data to form an agreement (e.g., an agreement for renting lodging). This operation can be performed in person, or over the network 188, etc. In such cases the entity 593 can even be an online seller, but that is not necessary. The transaction 597 will have data that is known to the entity 593, similarly with what was described by the relationship instance 197 of FIG. 1. In the present example, the transactions 597 may be made via a lodging marketplace entity 560.

In a number of instances, the user 592, the secondary entity 593 and/or the lodging marketplace entity 560 use software applications to manage their business activities, such as sales, resource management, production, inventory management, delivery, billing, and so on. The user 592, the secondary entity 593 and/or the lodging marketplace entity 560 may further use accounting applications to manage purchase orders, reservations, bookings, sales invoices, refunds, payroll, accounts payable, accounts receivable, and so on. Such software applications, and more, may be used locally by the user 592 or lodging marketplace entity 560, or from an Online Processing Facility (OPF) 589 that has been engaged for this purpose by the user 592, the lodging operator 593 and/or lodging marketplace entity 560. In such use cases, the OPF 589 can be a Mobile Payments system, a Point Of Sale (POS) system, an Accounting application, an Enterprise Resource Planning (ERP) system or provider, an e-commerce provider, an electronic marketplace, a Customer Relationship Management (CRM) system, and so on. In some embodiments, the OPF may be, or be used by, the lodging marketplace entity 560.

Businesses have tax obligations to various tax authorities of respective tax jurisdictions. A first challenge is in making the related determinations. Tax-related determinations, made for the ultimate purpose of tax compliance, are challenging because the underlying statutes and tax rules and guidance issued by the tax authorities are very complex. There are various types of tax, such as sales tax, use tax, excise tax, value-added tax, lodging tax, and issues about cross-border taxation including customs and duties, and many more. Some types of tax are industry specific. Each type of tax has its own set of rules. Additionally, statutes, tax rules, and rates change often, and new tax rules are continuously added. Compliance becomes further complicated when a taxing authority offers a temporary tax holiday, during which certain taxes are waived.

Tax jurisdictions are defined mainly by geography. Businesses have tax obligations to various tax authorities within the respective tax jurisdictions. There are various tax authorities, such as that of a country, of a state, of a municipality, of a local district such as a local transit district and so on. So, for example, when a business sells items in transactions that can be taxed by a tax authority, the business may have the tax obligations to the tax authority. These obligations include requiring the business to: a) register itself with the tax authority's taxing agency, b) set up internal processes for collecting sales tax in accordance with the sales tax rules of the tax authority, c) maintain records of the sales transactions and of the collected sales tax in the event of a subsequent audit by the taxing agency, d) periodically prepare a form (“tax return”) that includes an accurate determination of the amount of the money owed to the tax authority as sales tax because of the sales transactions, e) file the tax return with the tax authority by a deadline determined by the tax authority, and f) pay (“remit”) that amount of money to the tax authority. In such cases, the filing and payment frequency and deadlines are determined by the tax authority.

A technical challenge for businesses is that the above-mentioned software applications generally cannot provide tax information that is accurate enough for the businesses to be tax compliant with all the relevant tax authorities. The lack of accuracy may manifest itself as errors in the amounts determined to be owed as taxes to the various tax authorities, and it is plain not good to have such errors. For example, businesses that sell products and services have risks whether they over-estimate or under-estimate the sales tax due from a sale transaction. On the one hand, if a seller over-estimates the sales tax due, then the seller collects more sales tax from the buyers than was due. Of course, the seller may not keep this surplus sales tax, but instead must pay it to the tax authorities—if they cannot refund it to the buyers. If a buyer later learns that they paid unnecessarily more sales tax than was due, the seller risks at least harm to their reputation. Sometimes the buyer will have the option to ask the state for a refund of the excess tax by sending an explanation and the receipt, but that is often not done as it is too cumbersome. On the other hand, if a seller under-estimates the sales tax due, then the seller collects less sales tax from the buyers, and therefore pays less sales tax to the authorities than was actually due. That is an underpayment of sales tax that will likely be discovered later, if the tax authority audits the seller. Then the seller will be required to pay the difference, plus fines and/or late fees, because ignorance of the law is not an excuse. Further, one should note that sales taxes are considered trust-fund taxes, meaning that the management of a company can be held personally liable for the unpaid sales tax.

For sales in particular, making correct determinations for sales and use tax is even more difficult. There are a number of factors that contribute to its complexity.

First, some state and local tax authorities have origin-based tax rules, while others have destination-based tax rules. Accordingly, a sales tax may be charged from the seller's location or from the buyer's location.

Second, the various tax authorities assess different, i.e. non-uniform, percentage rates of the sales price as sales tax, for the purchase and sale of items that involve their various tax jurisdictions. These tax jurisdictions include various states, counties, cities, municipalities, special taxing jurisdictions, and so on. In fact, there are over 10,000 different tax jurisdictions in the US, with many partially overlapping.

Third, in some instances no sales tax is due at all because of the type of item sold. For example, in 2018 selling cowboy boots was exempt from sales tax in Texas, but not in New York. This non-uniformity gives rise to numerous individual taxability rules related to various products and services across different tax jurisdictions.

Fourth, in some instances no sales tax is due at all because of who the individual buyer is. For example, certain entities are exempt from paying sales tax on their purchases, so long as they properly create and sign an exemption certificate and give it to the seller for each purchase made. Entities that are entitled to such exemptions may include wholesalers, resellers, non-profit charities, educational institutions, etc. Of course, who can be exempt is not exactly the same in each tax jurisdiction. And, even when an entity is entitled to be exempt, different tax jurisdictions may have different requirements for the certificate of exemption to be issued and/or remain valid.

Fifth, it can be difficult to determine which tax authorities a seller owes sales tax to. A seller may start with tax jurisdictions that it has a physical presence in, such as a main office, a distribution center or warehouse, an employee working remotely, and so on. Such ties with a tax jurisdiction establish the so-called physical nexus. However, a tax authority such as a state or even a city may set its own nexus rules for when a business is considered to be “engaged in business” with it, and therefore that business is subject to registration and collection of sales taxes. These nexus rules may include different types of nexus, such as affiliate nexus, click-through nexus, cookie nexus, economic nexus with thresholds, and so on. For instance, due to economic nexus, a remote seller may owe sales tax for sales made in the jurisdiction that are a) above a set threshold volume, and/or b) above a set threshold number of sales transactions.

Even where a seller might not have reached any of the thresholds for economic nexus, a number of states are promulgating marketplace facilitator laws that sometimes use such thresholds. According to such laws, intermediaries that are characterized as marketplace facilitators per laws of the state have an obligation, instead of the seller, to collect sales tax on behalf of their sellers, and remit it to the state. The situation becomes even more complex when a seller sells directly to a state, and also via such an intermediary.

In an example case, the lodging marketplace entity 560 may electronically collect payment from the secondary entity 596 and electronically provide such payment (possibly minus a fee) to the lodging operator 593 via network 188. The lodging marketplace entity 560 may in various embodiments be a listing platform accessible via network 188 that advertises property listings for lodging stays and handles transactions for such lodging stays for a plurality of lodging operators or property owners such as lodging operator 593. The transaction 597 is an example of a relationship instance between the lodging operator 593 and the secondary entity 596. The transaction 597 may also be an example of a relationship instance between the lodging operator 593 and the lodging marketplace entity 560.

In some embodiments, along with collecting payment for the lodging stay on behalf of lodging operator 593, the lodging marketplace entity 560 may also collect lodging taxes due to one or more domains, such as one or more different tax authorities 581, 582 of respective tax jurisdictions in which the property is located or with which the property is associated. In various embodiments, the lodging marketplace entity 560 may collect such lodging taxes according to a VCA. As mentioned earlier, the VCA may be an agreement between the lodging marketplace entity 560 and a particular tax authority (such as one in the set 580 of tax authorities) for the lodging marketplace entity 560 to collect and/or remit, on behalf of property owners such as lodging operator 593, lodging taxes on all lodging stay transactions handled by the lodging marketplace entity 560 that are subject to lodging tax by that particular tax authority. However, the lodging marketplace entity 560 may not have a VCA with all the tax authorities for all the tax jurisdictions in which the property is located (e.g., state, county, city, other municipal or special tax jurisdictions, etc.). The lodging operator 593 may also or instead book lodging stays for and transact directly with occupants, such as secondary entity 596, for lodging stays at the same or different properties. The source of revenue for such lodging stays is referred to as a direct listing as opposed to a source of revenue associated with a VCA, such as the lodging marketplace entity 560. In such cases of direct listings, the lodging operator 593 may not even be aware of particular tax obligations and associated lodging taxes that the lodging marketplace entity 560 may or may not have otherwise collected (e.g., under terms of the VCA) if the transaction were made via the lodging marketplace entity 560. Thus, with multiple sources of revenue received for lodging stays in multiple different tax jurisdictions each having different tax regulations and rates, for which taxes may or may not have been collected, a technical problem is presented of how to ensure automatic calculation of tax obligations, preparation and filing of tax return documents and remittance of taxes in an accurate and timely manner. This problem is especially exacerbated for property owners with multiple different properties located in different tax jurisdictions, and that each have multiple different listings for short term stays using different listing platforms and direct listings.

To help with such complex determinations and solve such technical problems, the computer system 595 may be specialized device for tax compliance as disclosed herein. The computer system 595 may have one or more processors and memory, for example, as was described for the computer system 195 of FIG. 1. The computer system 595 thus implements a tax engine 583 to make the determinations of tax obligations and perform preparation and sending of associated tax return document(s). The tax engine 583 can be as described for the service engine 183.

The computer system 595 may further store locally entity data, i.e. data of user 592, of entity 593 and/or lodging marketplace entity 560, any of which/whom may be a customer, and/or a seller or a buyer in a sales transaction in various embodiments. The entity data may include profile data of the customer and transaction data (e.g., including a unique identifier associated with the lodging stay or a source of revenue for the lodging stay) from which a determination of a tax obligation is desired. In the online implementation of FIG. 5, the OSP 598 has a database 594 for storing the entity data. This entity data may be inputted by the user 592, and/or caused to be downloaded or uploaded by the user 592 from the computer system 590, from the lodging marketplace entity 560 or from the OPF 589, or extracted from the computer system 590 or from the lodging marketplace entity 560 or from the OPF 589, and so on. In other implementations, a simpler memory configuration may suffice for storing the entity data.

A digital tax content 586 is further implemented within the OSP 598. The digital tax content 586 can be a utility that stores digital tax and analytics rules 570 for use by the tax engine 583. As part of managing the digital tax content 586, there may be continuous updates of the digital tax rules, by inputs gleaned from a set 580 of different tax authorities 581, 582, . . . . Updating may be performed by humans, or by computers, and so on. As mentioned above, the number of the different tax authorities in the set 580 may be very large.

For a specific determination of a tax obligation, the computer system 595 may receive one or more datasets. A sample received dataset 535 is shown just below line 515, which can be similar to what was described for the dataset 135 of FIG. 1. In this example, the computer system 590 transmits a request 584 that includes a payload 534, and the dataset 535 is received by the computer system 595 parsing the received payload 534. In this example the single payload 534 encodes the entire dataset 535, but that is not required, as mentioned earlier.

In this example, the dataset 535 has been received because it is desired to determine any tax obligations arising from the buy-sell transaction 597. As such, the sample received dataset 535 has values that characterize attributes of the buy-sell transaction 597, as indicated by an arrow 599. (It should be noted that the arrow 599 describes a correspondence, but not the journey of the data of the buy-sell transaction 597 in becoming the received dataset 535.) Accordingly, in this example the sample received dataset 535 has a value ID for an identity of the dataset 535 and/or the transaction 597. The dataset 535 also has a value PE for the name of the lodging operator 593 or the user 592, which can be the seller making sales transactions, some online. The dataset 535 further has a value PD for relevant data of the lodging operator 593 or the user 592, such as an address, place(s) of business, prior nexus determinations with various tax jurisdictions, and so on. The dataset 535 also has a value SE for the name of the secondary entity 596, which can be the buyer. The dataset 535 further has a value SD for relevant data of the secondary entity 596, entity-driven exemption status, and so on. The dataset 535 has a value B2 for the sale price of the item sold (or in this case the price of the lodging stay).

The dataset 535 further has a value RS that includes a unique identifier that contains or identifies information identifying or regarding a revenue source system for revenue received for lodging stay transaction 597 and the location(s) of one or more properties being rented on the system. For example, the value RS may be or include a Globally Unique Identifier (GUID) or a Universally Unique Identifiers (UUID) that identifies a system of the lodging marketplace entity 560 as the source of revenue for the lodging stay transaction 597 and may also identify and/or include data regarding any VCAs that the lodging marketplace entity 560 has agreed to. The value RS may also indicate an amount of particular lodging taxes already collected for the transaction 597 by the lodging marketplace entity 560 under such VCAs. In another example, the value RS may identify the computer system 590 of the user 592 as the source of revenue for the lodging stay transaction 597 in the case of a direct listing. The value RS and/or other data in the dataset 535 may identify a location of the property of the lodging stay for the lodging stay transaction 597 for the tax engine 583 to determine which tax jurisdictions the property is located in, and thus which digital tax and analytics rules 570 (including specific tax rates) to apply and determine the overall tax obligation and individual tax obligations due to particular tax authorities 580. The dataset 535 may fewer values or have additional values, as indicated by the dot-dot-dot in the dataset 535. These values may characterize further attributes, such as characteristics of the property, data identifying of or otherwise relating to a license or registration required for the transaction, a date and possibly also time of the transaction 597, and so on.

The digital tax and analytics rules 570 have been created so as to accommodate tax rules that the set 580 of different tax authorities 581, 582 . . . promulgate within the boundaries of their tax jurisdictions. In FIG. 5, five sample digital tax rules are shown, namely T_RULE2 572, T_RULE3 573, T_RULE5 575, T_RULE6 576 and T_RULE7 577. Additional digital tax and analytics rules 570 are suggested by the vertical dot-dot-dots. Similarly with FIG. 1, some of these digital tax rules may be digital main rules that determine the tax obligation 579, while others can be digital precedence rules that determine which of the digital main rules is to be applied in the event of conflict. In some use cases, digital main rules may be about a sales tax, lodging tax or use tax being owed due to the transaction 597 at a certain percentage of the purchase price. Digital precedence rules may be digital tax rules that determine whether particular digital tax rules are to be applied for origin-based or destination-based jurisdictions, how to override for diverse taxability of individual items, for temporary tax holidays, for exemptions from having to pay sales tax based on who the buyer is, and also based on nexus, and so on. In the present example, digital precedence rules may be digital tax rules that determine whether particular digital tax rules (including specific lodging tax rates) are to be applied based on one or more tax jurisdictions in which a particular property is located and whether the source of revenue for the transaction indicates that a lodging tax has already been collected for one or more of those tax jurisdictions in which a particular property is located under one or more applicable VCAs associated with the particular revenue source.

In an example embodiment digital tax and analytics rules 570 may also include digital rules that indicate how to determine lodging inventory data of a particular lodging operator, such as lodging operator 593, in the one or more of a plurality of domains based on lodging operator data. The lodging operator data includes lodging stay data regarding lodging stays associated with the lodging operator extracted from dataset 535 and other data regarding the lodging operator included in dataset 535. Also, digital tax and analytics rules 570 may also include digital rules that indicate how and when to: electronically determine lodging inventory data of the lodging operator in the one or more of the plurality of domains based on the lodging operator data; electronically aggregate the determined lodging inventory data of each the plurality of lodging operators in the one or more of the plurality of domains; electronically generate domain-specific lodging inventory data for each domain of the one or more of the plurality of domains based on the aggregated lodging inventory data; electronically generate, based on the lodging stay data and the domain-specific lodging inventory data, lodging occupancy rates of lodging inventory for the one or more of the plurality of domains; and electronically determine prediction values (e.g., lodging analytics values 549) of future resources associated with future lodging stays in the one or more of the plurality of domains. The lodging analytics values 549 are determined by the lodging data and analysis engine 543 according to the digital tax and analytics rules 570 based on the generated domain-specific lodging inventory data and the generated lodging occupancy rates.

Similarly with FIG. 1, these digital tax and analytics rules 570 can be implemented or organized in different ways. In some use cases they can be organized with conditions and consequents, such as was described earlier in this document. Such conditions may relate to geographical boundaries, sources of revenue, effective dates, and so on, for determining where and when a digital tax rule or tax rate is to be applied. These conditions may be expressed as logical conditions with ranges, dates, other data, and so on. Values of the dataset 535 can be iteratively tested against these logical conditions according to arrows 571. In such cases, the consequents may indicate one or more tax obligations, such as to indicate different types of taxes that are due, rules, rates, exemption requirements, reporting requirements, remittance requirements, etc.

In this example, a certain digital tax rule T_RULE6 576 is shown as identified and used, which is indicated also by the beginning of an arrow 578. Identifying may be performed responsive to the values of the dataset 535, which are shown as considered for digital tax and analytics rules 570 by arrows 571. For example, it can be recognized that a condition of the digital tax rule T_RULE6 576 is met by one or more of the values of the dataset 535. For instance, it can be further determined that the source of revenue for lodging transaction 597 is lodging marketplace entity 560, that the location of the property is in a tax jurisdiction of tax authority 581 that has a VCA with marketplace entity 560, and thus the tax rate(s) to be applied for calculating a total tax obligation for the transaction include those of other tax jurisdictions in which the property is also located that do not have a VCA with marketplace entity 560.

As such, the computer system 595 may produce the tax obligation 579 and tax return document, which is akin to producing the resource 179 of FIG. 1. The computer system 595 may also file or otherwise send (or cause to be filed or sent) the tax return document to one or more of the applicable tax authorities in the set of tax authorities 580 via network 188. The tax obligation 579 can be produced by the computer system 595 applying the certain digital tax rule T_RULE6 576, as indicated by the arrow 578. In this example, the consequent of the identified certain digital tax rule T_RULE6 576 may specify that a lodging tax is due, the amount is to be determined by a multiplication of the sale price of the value B2 by a specific rate, the tax return form that needs to be prepared and filed, a date by which it needs to be filed, and so on.

The computer system 595 may then cause a notification 536 to be transmitted. The notification 536 can be about an aspect of the tax obligation 579, similarly with the notification 136 of FIG. 1. In the example of FIG. 5, the notification 536 is caused to be transmitted by the computer system 595 as an answer to the received dataset 535. The notification 536 can be about an aspect of the tax obligation 579. In particular, the notification 536 may inform about the aspect of the tax obligation 579, namely that it has been determined, where it can be found, what it is, or at least a portion or a statistic of its content, and so on.

The notification 536 can be transmitted to one of an output device and another device that can be the remote device, from which the dataset 535 was received. The output device may be the screen of a local user or a remote user. The notification 536 may thus cause a desired image to appear on the screen, such as within a Graphical User Interface (GUI) and so on. The other device may be a remote device, as in this example. In particular, the computer system 595 causes the notification 536 to be communicated by being encoded as a payload 537, which is carried by a response 587. The response 587 may be transmitted via the network 188 responsive to the received request 584. The response 587 may be transmitted to the computer system 590, lodging marketplace entity 560 or to OPF 589, and so on. As such, the other device can be the computer system 590, or a device of the OPF 589, or the screen 591 of the user 592, and so on. In this example the single payload 537 encodes the entire notification 536, but that is not required, similarly with what is written above about encoding datasets in payloads. Along with the aspect of the tax obligation 579, it is advantageous to embed in the payload 537 the ID value and/or one or more values of the dataset 535. This will help the recipient correlate the response 587 to the request 584, and therefore match the received aspect of the tax obligation 579 as the answer to the received dataset 535.

Also, in this example, a certain digital analytics rule T_RULE6 577 is shown as identified and used, which is indicated also by the beginning of an arrow 548. Identifying may be performed responsive to the values of the dataset 535, which are shown as considered for digital tax and analytics rules 570 by arrows 571. For example, it can be recognized that a condition of the digital analytics rule T_RULE6 577 is met by one or more of the values of the dataset 535. For instance, it can be further determined that the source of revenue for lodging transaction 597 is lodging marketplace entity 560, that the location of the property is in a tax jurisdiction of tax authority 581 that has a VCA with lodging marketplace entity 560, and thus the tax rate(s) to be applied for calculating a total tax obligation for the transaction include those of other tax jurisdictions in which the property is also located that do not have a VCA with marketplace entity 560 and which also triggers the lodging data analysis engine 543 to determine what percentage of the property's bookings were generated directly by property managers, such as lodging operator 593 versus lodging marketplace entities (e.g., VRBO, AirBnB, etc.), such as lodging marketplace entity 560 (using mixed liability data reported on the lodging tax return document 579). This helps the property owner, manager and/or investor predict future source of cashflows from the property. The OSP 598 also determines data indicative of which method of listing (e.g., direct listing or via the lodging marketplace operator) is most effective for the property.

As such, the computer system 595 may produce the lodging analytics values 549 including such data described above, which is akin to producing the prediction value 149 of FIG. 1. The lodging analytics values 549 can be produced by the computer system 595 applying the certain digital analytics rule T_RULE6 577, as indicated by the arrow 548. In this example, the consequent of the identified certain analytics rule T_RULE6 577 may specify one or more of: a predicted future source of cash flows from the property, particular lodging price recommendation; lodging pricing recommendations; which method of listing (e.g., direct listing or via the lodging marketplace operator) is most effective for the property; an index that measures the economic health of the short-term rental market by locality; predictions regarding the success of listing property on an online marketplace based on anonymized tax return data generated by tax engine 583 for hundreds or thousands of short term rental properties, which is more accurate and up-to-date; values representing supply of lodging in the in the one or more of the plurality of domains based on the domain-specific lodging inventory data; a data stream that includes comparisons of aggregated lodging tax return data generated from tax engine 583 for a plurality of lodging operators and/or lodging marketplace entities against short-term rental licensing and/or registration for a plurality of lodging operators for a plurality of different domains (e.g., geographical areas); values representing demand for lodging in the in the one or more of the plurality of domains based on the generated lodging occupancy rates; a snapshot of the current state of the short term rental market in a given domain and other data regarding short term rental market, pricing and/or statistics.

The computer system 595 may then cause a notification 546 to be transmitted. The notification 546 can be about an aspect of the lodging analytics values 549, similarly with the notification 146 of FIG. 1. In the example of FIG. 5, the notification 546 is caused to be transmitted by the computer system 595 as an answer to the received dataset 535 and/or request 584. In particular, the notification 546 may inform about the aspect of the tax lodging analytics values 549, namely that it has been determined, where it can be found, what it is, or at least a portion or a statistic of its content, and so on.

The notification 546 can be transmitted to one of an output device and another device that can be the remote device (e.g., from which the dataset 535 was received). The output device may be the screen of a local user or a remote user. The notification 546 may thus cause a desired image to appear on the screen, such as within a Graphical User Interface (GUI) and so on. The other device may be a remote device, as in this example. In particular, the computer system 595 causes the notification 546 to be communicated by being encoded as a payload 537, which is carried by a response 587. The response 587 may be transmitted via the network 188 responsive to the received request 584. The response 587 may be transmitted to the computer system 590, lodging marketplace entity 560 or to OPF 589, and so on. As such, the other device can be the computer system 590, or a device of the OPF 589, or the screen 591 of the user 592, and so on. In this example the single payload 537 encodes the entire notification 546, but that is not required, similarly with what is written above about encoding datasets in payloads. Along with the aspect of the lodging analytics values 549, it is advantageous to embed in the payload 537 the ID value and/or one or more values of the dataset 535. This will help the recipient correlate the response 587 to the request 584, and therefore match the received aspect of the lodging analytics values 549 as the answer to the received dataset 535 and/or request 584.

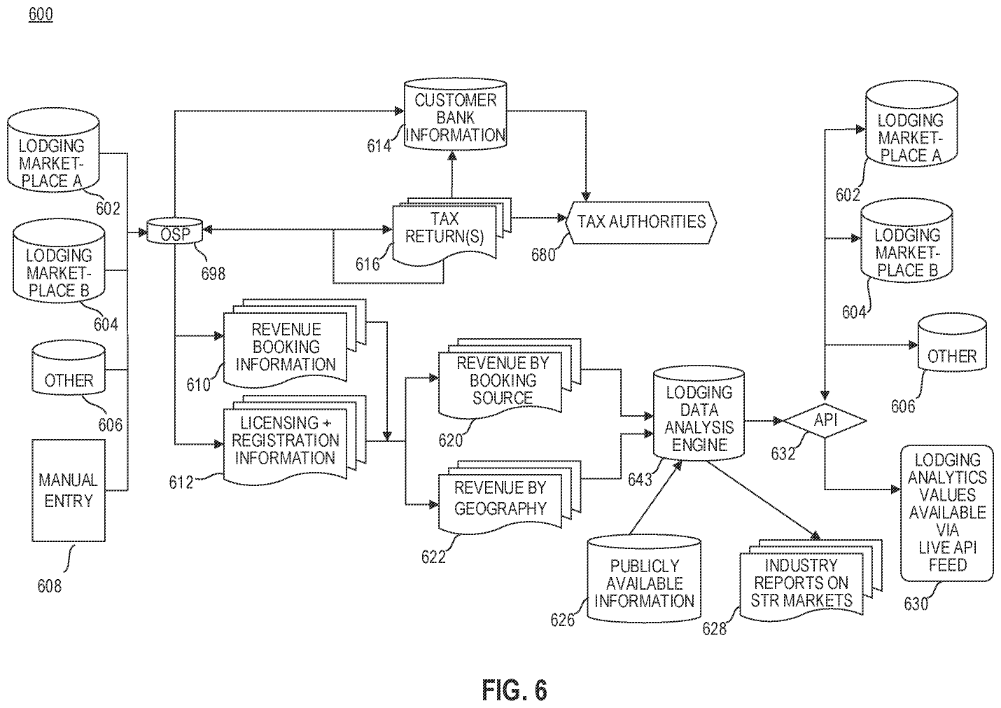

FIG. 6 is an overview block diagram illustrating an example dynamic lodging resource prediction system 600 including a lodging data analysis engine 643 and a technical environment in which the system may be implemented that is an improvement in automated computerized systems, according to various embodiments of the present disclosure.

Shown is an OSP 698, which may be an example of the OSP 598 of FIG. 5; a lodging data analysis engine 643, which may be an example of the lodging data analysis engine 543 of FIG. 5; lodging marketplace A 602, which may be an example of lodging marketplace entity 560 of FIG. 5; lodging marketplace B 604, which may be an example of lodging marketplace entity 560 of FIG. 5; and tax authorities 680, which may be an example of the set of tax authorities 580 of FIG. 5.

The lodging data analysis engine 643 identifies the sources 620 of rental income based on revenue booking information 610. For example, revenue booking information 610 may include data indicating or identifying direct bookings/property manager bookings, which require or incur 100% tax liability on the part of the property manager or lodging operator; marketplace bookings received from or paid via lodging marketplace operators (e.g., lodging marketplace A 602 and lodging marketplace B 604), such as AirBnB, VRBO, etc., which may require or incur partial tax liability on the part of the lodging marketplace entity; manual entry of information 608 from lodging operators and/or lodging market place operators; and other sources 606, such as automated POS and other ERP systems of lodging operators via OSP 698.

Using information on the lodging tax return(s) 616 prepared by the OSP 698, the lodging data analysis engine 643 electronically generates industry reports on short term rental (STR) markets 628 and lodging analytics values 630 via API 632. The industry reports on short STR markets 628 and lodging analytics values 630 may include an index for the local STR market based on financial metrics such as rental revenue growth, average duration of stay(s), and tax assessed values, amongst other data points that are contained on the lodging tax return(s) 616 and/or are publicly available via electronic access to public available information 626 (e.g., data feeds, databases publicly accessible via the Internet and web sites). The lodging data analysis engine 643 compares the income and rental data to license and registration information 612 received via the OSP 698 to determine the occupancy rates relative to rental inventory.

The lodging data analysis engine 643 analyzes what percentage of the property's bookings were generated by property managers (e.g., lodging operators) vs. lodging marketplaces, such as lodging marketplace A 602 and lodging marketplace B 604 (e.g., VRBO, AirBnB, etc.) using mixed liability data reported on the lodging tax return(s) 616 associated with the lodging property. This helps the property owner, manager and/or investor predict future sources of cash flows from the property. The lodging data analysis engine 643 also determines which method of listing is most effective for a given property. An index is published via API 632 which may include or comprise the lodging analytics values 630 as part of the and an electronic industry publication is generated, which analyzes the economic health of short term rentals in a given region, which may be include in or comprise the industry reports on STR markets 628. The lodging data analysis engine 643 also generates and provides via API 632 real-time pricing recommendations for a given property which may be included in or comprise the lodging analytics values 630. In some embodiments, the API 632 is integrated with and/or communicates with listing platforms, marketplaces, ERP systems and other applications.

Dynamic pricing recommendations are created by the lodging data analysis engine 643 using tax return data, such as from tax return(s) 616 and a continuous feedback loop between the API 632 and any integrated entities, such as lodging marketplaces (e.g., lodging marketplace A 602 and lodging marketplace B 604), tax authorities 680, and other systems 606, including those of lodging operators and other ERP systems. For example, the feedback loop may include data from lodging marketplaces indicating current lodging prices for comparable properties in the same domain (e.g., locality or geographic area) of the property for which dynamic pricing is generated. The lodging data analysis engine 643 may then adjust recommended lodging prices for the property based on such feedback data. In an example embodiment, the lodging data analysis engine 643 utilizes artificial intelligence and/or machine learning trained on such feedback data, previous price recommendations and/or other prediction values and correlates those to other data received by the lodging data analysis engine 643 to adjust recommended prices and other prediction values accordingly in real time or near real time. Such adjusted data may then be electronically provided as a data stream via the API 632 automatically, thus increasing and improving the accuracy and efficiency of the computerized automated enterprise resource planning (ERP) technology and networks.

In various example embodiments, booking revenue from one or more lodging marketplaces such as lodging marketplace A 602 and lodging marketplace B 604 (e.g., VRBO, AirBnB, etc.) is transmitted to the lodging data analysis engine 643 via the OSP 698. In some embodiments, this may be performed and/or facilitated by a secure electronic triple entry ledger system in which such transactions and/or revenue received therefrom are securely recorded and/or tracked. Entities referencing the electronic ledger that are associated with a transaction can form a consensus that the outcome of the transaction is legitimate and determine whether future transactions between entities are compliant. An authority entity publishes to the secure electronic ledger data on which digital rules regarding aspects of the transaction between a first entity and second entity are based. Entities subscribed to the secure electronic ledger make digitally signed entries in real-time in the secure electronic ledger including data regarding the transaction that are visible by all entities associated with the relationship instance. A trusted third entity is electronically entrusted, by at least the system of the first entity and a system of an authority entity, to validate in real-time the data regarding the transaction contained in the entries and all such entries may be approved or rejected in real-time by one or more entities associated with the transaction. The approvals and rejections of the entries in the secure electronic ledger, and reasons therefor, are also recorded and visible in the secure electronic ledger to all entities associated with the transaction. The OSP 698, and thus the lodging data analysis engine 643, may be that of such a trusted entity in the ledger system. One or more lodging marketplaces, such as lodging marketplace A 602 and lodging marketplace B 60, or other lodging operators may be other authorized entities that reference or otherwise have access to the secure electronic ledger for transactions involving the lodging marketplaces or other lodging operator, and can therefore automatically access the booking revenue from one or more lodging marketplaces and/or lodging operators via the secure electronic ledger, thus speeding up and improving the operation of such computerized ERP technology.

In an example embodiment, the OSP 698 aggregates bookings revenue data represented by revenue booking information 610 from different sources from a single client, such as a lodging operator and electronically generates one or more generates tax return(s) 616 for the client. For example, such sources may include one or more of: lodging market place operators (e.g., lodging marketplace A 602 and lodging marketplace B 604), such as AirBnB, VRBO, etc., manual entry of information 608 from lodging operators and/or lodging market place operators, and other sources 606, such as automated POS and other ERP systems of lodging operators and/or lodging market place operators. Such automated POS and other ERP systems of lodging operators and/or lodging marketplace operators may be electronically coupled to the OSP 698 via API 632 such that bookings revenue data may be automatically communicated over computer networks from hundreds or thousands of data sources concurrently or simultaneously, such that the bookings revenue data from hundreds or thousands of data sources may be processed by the OSP 698 concurrently or simultaneously to increase and improve the efficiency of ERP systems of lodging operators and/or lodging marketplace operators. In some embodiments, simultaneously with receiving and processing the bookings revenue data represented by revenue booking information 610, the OSP 698 system triggers a treasury function that initiates a funding pull from a the lodging operator's bank account represented by customer banking information 614. The tax return(s) 616, and the corresponding monies may then be electronically remitted to the appropriate tax authorities 680. However, this treasury function and remitting step is not required in various other embodiments.

Execution of a background job is initiated by the OSP 698 that extracts lodging licensing and registration information 612 from one or more of the various data sources described herein, as well as revenues by booking source 620 and geographic information, such as revenue by geography 622, and automatically pushes the data electronically to the lodging data analysis engine 643. In some embodiments, to improve accuracy, execution of the background job that extracts such data may optionally be triggered in response to the tax return(s) 616 having been accepted by tax authorities 680. For example, such acceptance may be communicated via the secure electronic ledger system described above. In various embodiments, pushes of such data may align to the frequency of tax returns per jurisdiction. For example, a jurisdiction may require lodging tax returns to be filed monthly while other jurisdictions may require filings on a quarterly basis. Data pushes have a one to one relationship with the tax returns that are filed.

The present example embodiment, the lodging data analysis engine 643 consumes all the data from the various sources as described above and initiates the following electronic actions for hundreds or thousands of rental properties simultaneously or concurrently: performing data extraction from each tax return, including extraction of property address, gross receipts, revenue generated by each lodging marketplace, such as lodging marketplace A 602 and lodging marketplace B 604 (e.g. VRBO, AirBnB, etc.) and revenue generated through direct bookings and any additional detail pertinent to rental activity in a given jurisdiction (e.g. average nightly rate, total night(s) stayed, etc.); continuously pulling of short term rental information from publicly available data sources (e.g. public records) represented by publicly available information 626; and comparing publicly available information with rental information to assess supply and demand for short term rentals in a given market, average prices and occupancy rates, volumes of new licenses/registrations which impact the supply of short term rentals in a given market, the valuation of home, condo, etc., prices relative to rental rates and prices, and additional miscellaneous financial metrics that inform pricing for rentals and real estate.

Using information generated from initiating and/or performing the electronic actions above, the lodging data analysis engine 643 generates pricing recommendations for lodging for particular properties and/or particular domains (e.g., geographic areas) and other real estate investment metrics, and makes them available via API 632. Such data is represented by lodging analytics values available via API feed 630. The API 632 is capable of both pushing and accepting data to and from external sources. This is primarily used to create a continuous feedback loop in marketplaces for validating pricing recommendations available via API 632 and adjusting them in real time. Statistical information related to pricing is pushed back to the lodging data analysis engine 643 from one or more lodging marketplaces, such as lodging marketplace A 602 and lodging marketplace B 604, and used by the lodging data analysis engine 643 to refine future pricing recommendations for lodging simultaneously or concurrently as new revenue booking information 610 is being received and processed by the lodging data analysis engine 643, thus improving and increasing efficiency and accuracy of ERP technology.

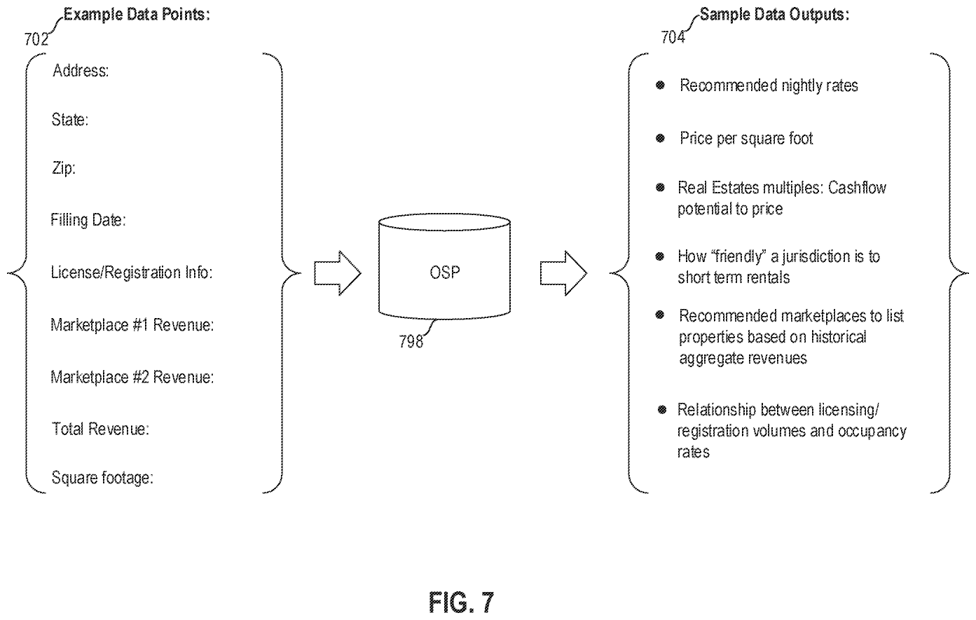

FIG. 7 is a data flow diagram that shows an example data flow through an online software platform (OSP) in a dynamic lodging resource prediction system and illustrates an improvement in automated computerized systems, according to various embodiments of the present disclosure.

Example data points 702 are input, either manually or by automatic extraction from various sources as described herein, to OSP 798. OSP 798 may be an example of OSP 198, OSP 598 and/or OSP 698. Such example data points may include, but are not limited to the following data regarding a lodging operator's property at which lodging stays occur: property address, property state, property zip code, filing date of tax return for lodging property, lodging property or lodging operator license/registration information, lodging revenue from lodging marketplace 1, lodging marketplace 2, total lodging revenue and square footage of property. In some embodiments, the lodging operator license/registration information and/or square footage may be indicative of how many units and/or total square footage is available for lodging stays at the particular property, and thus inform or indicate a potential supply of lodging available for rent at the property. The OSP 798 may automatically generate sample data outputs 704 based on example data inputs 702 received simultaneously or concurrently from hundreds or thousands of lodging operators for corresponding hundreds or thousands of lodging properties to improve the efficiency and accuracy of providing such data by ERP technology. For example, the sample data outputs may include, but are not limited to data including or indicative of the following regarding lodging for one or more particular lodging properties: recommended nightly rates; price per square foot, real estate multiples including cash flow potential to price; how “friendly” or conducive a jurisdiction is to short term rentals; recommended marketplaces to list properties based on historical aggregate revenues; and a relationship between licensing/registration volumes and occupancy rates. Such sample data outputs may include, comprise, or be represented by, prediction value 149 and/or lodging analytics values 549.

In an example embodiment, the example data points 702 data points are electronically and automatically pushed to the lodging data analysis engine 543 which performs statistical calculations and provide them via API to any API level integration with external systems, such as via API 632. Some example calculations which may be included in the sample data outputs 704 include pricing recommendations, estimated rental inventory, real estate valuations, and marketplace listing recommendations. The OSP 598 may filter and present such data at the state, local, and zip code levels. The OSP 598 may also make this data electronically available in real-time, such as via API 632.

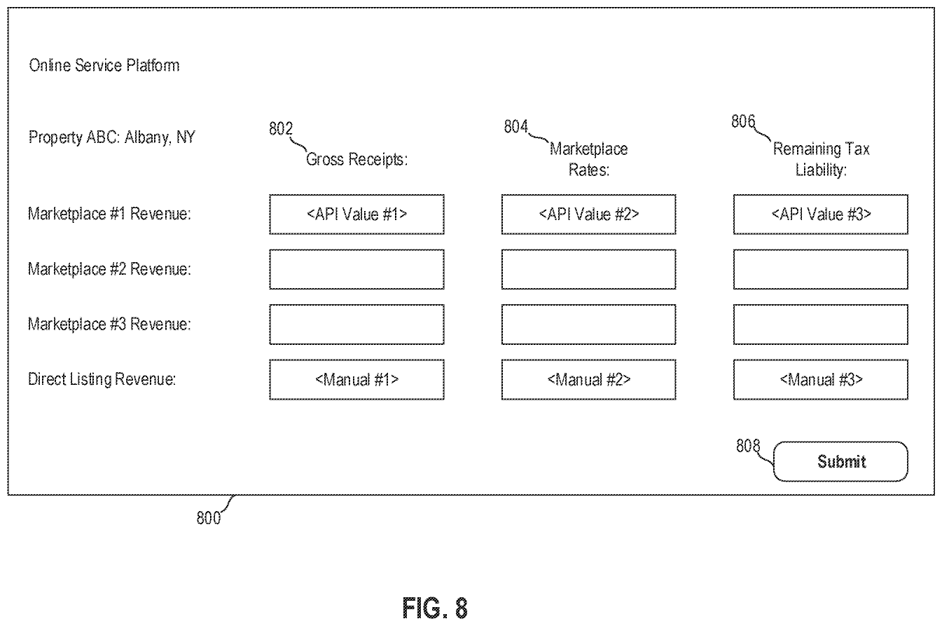

FIG. 8 is a sample view of a User Interface (UI) 800 for an OSP in which lodging revenue data is provided or auto-filled in a dynamic lodging resource prediction system in a use case of an embodiment according to various embodiments of the present disclosure. For example, the UI 800 may be that provided or generated by OSP 598 and data input and/or displayed in the UI 800 may include or comprise data represented by the example data points 702 of FIG. 7, the revenue booking information 610 of FIG. 6 and/or the dataset 535 of FIG. 5. In the present example embodiment, inputs fields for gross receipts 802 of the lodging property appear in a column adjacent or next to input fields for marketplace rates 804 of the lodging property, which appear in a column adjacent or next to input fields for the remaining tax liability 806 for the property in addition to the tax liability computed based on lodging marketplace rates 804. Rows indicate each source of revenue (e.g., marketplace #1 revenue, marketplace #2 revenue, marketplace #3 revenue, direct listing revenue) for which the gross receipts 802, marketplace rates 804 and remaining tax liability 806 are input or otherwise provided. In various embodiments, the data may be manually input or automatically pre-filled by the OSP 598, or via communication with an API electronically coupled to a tax engine or other computerized data system in the process of preparing tax returns or other tax computations for the lodging operator of the particular property. For example, the data gross receipts 802, marketplace rates 804 and remaining tax liability 806 data for marketplace #1 revenue is automatically filled via electronic communication with an API that is electronically coupled to a tax engine (e.g., tax engine 583) that has automated access to lodging transaction data for marketplace #1 listing the property. However, in the present example the gross receipts 802, marketplace rates 804 and remaining tax liability 806 data for direct listing revenue may be manually entered by the lodging operator. The UI 800 also display a selectable submit button 808 that submits the input data to the lodging data analysis engine 543 and/or tax engine 583 such that digital rules 570 may be applied to generate the lodging analytics values 549.

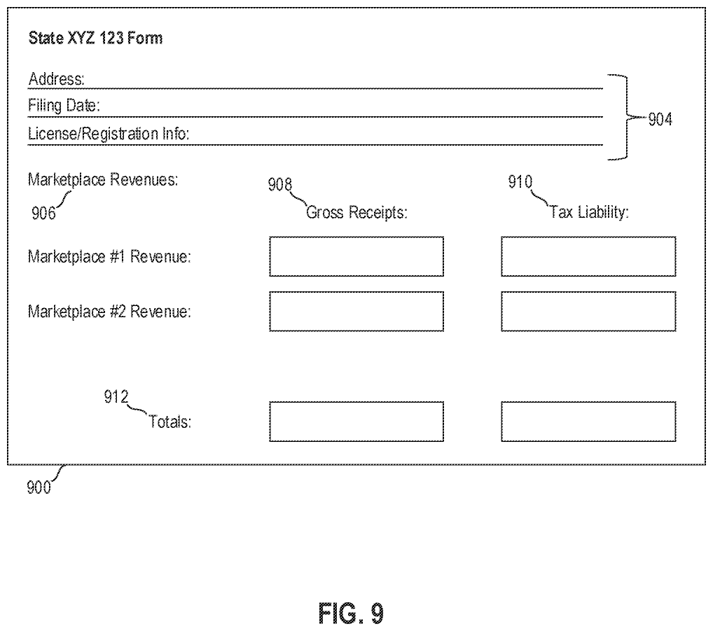

FIG. 9 is a sample view of a User Interface (UI) 900 for an OSP illustrating an example electronic lodging tax return document from which data may be automatically extracted in a dynamic lodging resource prediction system in a use case of an embodiment according to various embodiments of the present disclosure. Such data displayed in and/or provided by the example electronic lodging tax return document in the UI 900 may include or comprise data represented by the example data points 702 of FIG. 7, the revenue booking information 610 of FIG. 6 and/or the dataset 535 of FIG. 5. In the present example embodiment, the example electronic lodging tax return document provided in the UI 900 (which may, for example, be generated by the OSP 598) may include data indicative of lodgin marketplace revenues 906 that are received through bookings (i.e., lodging stays) of the property made or paid via online lodging marketplace systems, including gross receipts 908 and tax liability 910 in a particular state for a particular lodging property and a particular tax reporting period for each applicable lodging marketplace and totals of the gross receipts 908 and tax liability 910 for all applicable lodging marketplaces. Such data, including other relevant property and lodging operator data 904 (e.g., property address, tax return filing date and lodging license and registration information) may be automatically extracted by the OSP 598 from the electronic lodging tax return document generated by the OSP 598 and/or underlying data sources providing such data for the electronic lodging tax return document. The lodging data analysis engine 543 may then apply digital rules 570 to such data to generate the lodging analytics values 549.

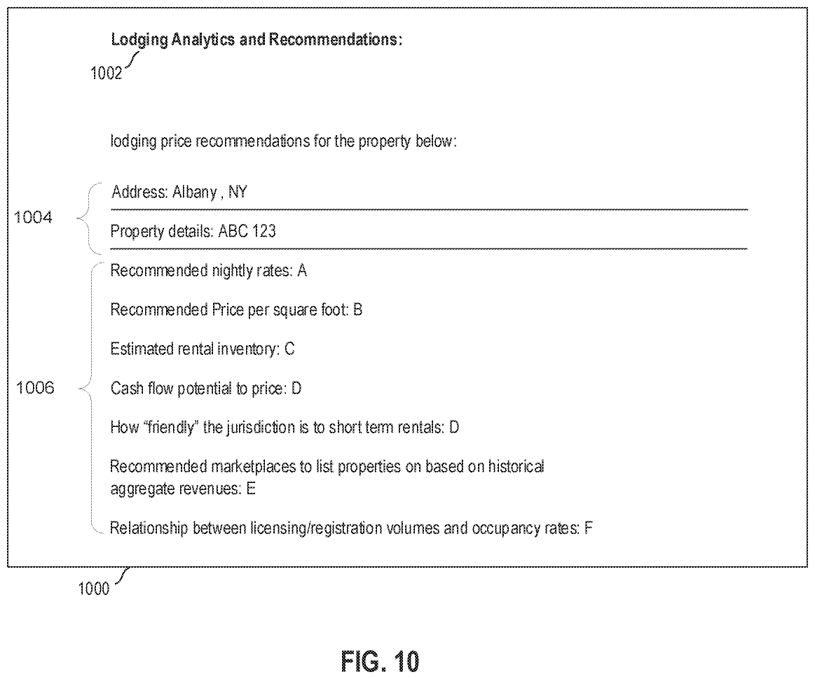

FIG. 10 is a sample view of a User Interface (UI) 1000 for an OSP illustrating an example output from a dynamic lodging resource prediction system in a use case of an embodiment according to various embodiments of the present disclosure. For example, the UI 1000 may be that provided or generated by OSP 598 based on the data input via UI 800 and UI 900. For example, the UI 1000 may be that provided or generated by OSP 598 in response to a user selection of the submit button 808 in UI 800. The lodging analytics and recommendations, including lodging price recommendations displayed in the UI 1000 may include or comprise data represented by the sample data outputs 704 of FIG. 7; the lodging analytics values 630 and/or industry reports 628 of FIG. 6; and/or the lodging analytics values of FIG. 5. In an example embodiment, the UI 1000 or data displayed therein may include or comprise the notification 546 of FIG. 5. Displayed in UI 1000 is a section including property details 1004 such as the address and other property details. Below or adjacent to the property details 1004, displayed is price recommendation section 1006 for the particular property including data generated by the lodging data analysis engine 543, including recommended nightly rates, recommended price per square foot, estimated rental inventory, cash flow potential to price, how “friendly” or conducive the jurisdiction is to short term rentals, recommended marketplaces to list properties on based on historical, aggregate revenues, and relationship between licensing and registration volumes and occupancy rates. Additional or fewer data may be displayed in various other embodiments. In some embodiments, one or more of each row of data displayed in the price recommendation section 1006 may be a selectable UI element, the selection of which automatically causes the UI 1000 to display data indicative of how the particular data (e.g., recommended nightly rates) displayed in the row was computed or the data on which the computation was based.

The embodiments described above may also use synchronous or asynchronous client-server computing techniques, including software as a service (SaaS) techniques. However, the various components may be implemented using more monolithic programming techniques as well, for example, as an executable running on a single CPU computer system, or alternatively decomposed using a variety of structuring techniques known in the art, including but not limited to, multiprogramming, multithreading, client-server, or peer-to-peer, running on one or more computer systems each having one or more CPUs. Some embodiments may execute concurrently and asynchronously, and communicate using message passing techniques. Equivalent synchronous embodiments are also supported. Also, other functions could be implemented and/or performed by each component/module, and in different orders, and by different components/modules, yet still achieve the functions of the systems and methods described herein.

In addition, programming interfaces to the data stored as part of the system controller 210 and other system components described herein may be available by mechanisms such as through C, C++, C#, and Java APIs; libraries for accessing files, databases, or other data repositories; through scripting languages such as JavaScript and VBScript; or through Web servers, FTP servers, or other types of servers providing access to stored data. The databases described herein and other system components may be implemented by using one or more database systems, file systems, or any other technique for storing such information, or any combination of the above, including implementations using distributed computing techniques.

Different configurations and locations of programs and data are contemplated for use with techniques described herein. A variety of distributed computing techniques are appropriate for implementing the components of the embodiments in a distributed manner including but not limited to TCP/IP sockets, RPC, RMI, HTTP, Web Services (XML-RPC, JAX-RPC, SOAP, and the like). Other variations are possible. Also, other functionality may be provided by each component/module, or existing functionality could be distributed amongst the components/modules in different ways, yet still achieve the functions described herein.

Where a phrase similar to “at least one of A, B, or C,” “at least one of A, B, and C,” “one or more A, B, or C,” or “one or more of A, B, and C” is used, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

As used herein, the term “or” may be construed in either an inclusive or exclusive sense. Moreover, plural instances may be provided for resources, operations, or structures described herein as a single instance. Additionally, particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A system, including:
at least one processor; and
a memory coupled to the at least one processor, the memory storing instructions that, when executed by the at least one processor, cause the system to perform operations including:
for each lodging operator of a plurality of lodging operators:
electronically obtaining, by a computer device, lodging operator data in which the lodging operator data includes lodging stay data regarding lodging stays associated with the lodging operator and other data regarding the lodging operator;
electronically determining, by a computer device, based on the lodging operator data, an amount of resources to be remitted to an authority associated with one or more of a plurality of domains in which the lodging stays occurred; and
electronically determining, by a computer device, lodging inventory data of the lodging operator in the one or more of the plurality of domains based on the lodging operator data;
electronically aggregating, by a computer device, the determined lodging inventory data of each the plurality of lodging operators in the one or more of the plurality of domains;
electronically generating, by a computer device, domain-specific lodging inventory data for each domain of the one or more of the plurality of domains based on the aggregated lodging inventory data;
electronically generating, by a computer device, based on the lodging stay data and the domain-specific lodging inventory data, lodging occupancy rates of lodging inventory for the one or more of the plurality of domains; and
electronically determining, by a computer device, a prediction value of future resources associated with future lodging stays in the one or more of the plurality of domains, the prediction value being determined based on the generated domain-specific lodging inventory data and the generated lodging occupancy rates.

2. The system of claim 1 in which the electronically determining the prediction value includes:
comparing the generated domain-specific lodging inventory data to the generated lodging occupancy rates; and
determining the prediction value based on the comparison of the domain-specific lodging inventory data to the generated lodging occupancy rates.

3. The system of claim 1 in which the prediction value represents an amount of resources recommended for one or more lodging operators of the plurality of lodging operators to receive for providing lodging stays in the one or more of the plurality of domains.

4. The system of claim 3 in which determining the prediction value based on the comparison of the lodging inventory data to the generated lodging occupancy rates includes:
determining values representing demand for lodging in the in the one or more of the plurality of domains based on the generated lodging occupancy rates;
determining values representing supply of lodging in the in the one or more of the plurality of domains based on the domain-specific lodging inventory data; and
comparing the values representing demand with the values representing supply;
determining the prediction value based on the comparison of the values representing demand with the values representing supply.

5. The system of claim 1 in which the instructions, when executed by the at least one processor, further cause the system to perform operations including:
using, by a computer device, the prediction value to generate a recommendation value representing an amount of resources recommended for one or more lodging operators of the plurality of lodging operators to receive for providing lodging stays in the one or more of the plurality of domains; and
transmitting, by a computer device, the recommendation value to the one or more of the lodging operators.

6. The system of claim 1 in which the instructions, when executed by the at least one processor, further cause the system to perform operations including:
using, by a computer device, the prediction value to generate metrics data for recommending an amount of resources one or more lodging operators of the plurality of lodging operators to receive for providing lodging stays in the one or more of the plurality of domains; and
transmitting, by a computer device, the recommendation value to the one or more of the lodging operators.

7. The system of claim 6 in which the instructions, when executed by the at least one processor, further cause the system to perform operations including:
receiving, by a computer networking system over a computer network from a remote computing system, via an application programming interface (API) of the computer networking system, a request for the metrics data; and
in response to receiving the request via the API of the computer networking system, automatically transmitting, by a computer networking system via the API, the metrics data to the remote computer device;
transmitting, via the API over a computer network, a request to one or more remote computer devices for resource data including current amounts of resources various lodging operators are currently requesting to receive for lodging stays in the one or more of the plurality of domains;
in response to transmitting the request via the API, electronically receiving feedback resource data including current amounts of resources various lodging operators are currently requesting over one or more specific time periods to receive for providing lodging stays in the one or more of the plurality of domains;
comparing, by a computer networking system, the received resource data to the metrics data to determine differences between the received feedback resource data and the metrics data;
updating, by a computer networking system, the metrics data based on the determine differences between the received feedback resource data and the metrics data;
in response to updating the metrics data, automatically transmitting, by a computer networking system via the API, the updated metrics data to the remote computer device; and
continuing to automatically update, by a computer networking system, the updated metrics data based on determined differences between additional feedback resource data and the updated metrics data as the additional feedback resource data is received to increase accuracy of the metrics data.

8. The system of claim 1 in which the determining lodging inventory data of the lodging operator in the one or more of the plurality of domains based on the lodging operator data includes:
for each lodging operator of the plurality of lodging operators:
extracting data indicative of lodging licensing and registration information of the lodging operator based on the lodging operator data; and
determining lodging inventory of the lodging operator based on the extracted data indicative of lodging licensing and registration information for the lodging operator.

9. The system of claim 8 in which the determining lodging inventory data further includes:
for each lodging operator of the plurality of lodging operators:
periodically electronically polling, by a computer device, using the lodging operator data, public electronic listings of lodging available from the lodging operator;
in response to the electronically polling the public electronic listings, receiving, by a computer device, data indicative of the lodging available from the lodging operator on the public electronic listings; and
determining, by a computer device, lodging inventory of the lodging operator additionally based on the received data indicative of the lodging available from the lodging operator on the public electronic listings.

10. The system of claim 1, in which the instructions, when executed by the at least one processor, further cause the system to perform operations including:
for each lodging operator of a plurality of lodging operators, electronically remitting, by a computer device, on behalf of the lodging operator, to a computer device of the authority, the amount of resources to be remitted to the authority by electronically pulling the amount of resources from an account of the lodging operator.

11-30. (canceled)
